(19) United States
(12) Patent Application Publication
(10) Pub. No.: US 2022/0294697 A1
(43) Pub. Date: Sep. 15, 2022

(54) Methods of Translating Cyber-Physical Control Application Requirements to Radio Parameters

(71) Applicant: Telefonaktiebolaget LM Ericsson (publ), Stockholm (SE)

(72) Inventors: Milad Ganjalizadeh, Solna (SE); Abdulrahman Alabbasi, Kista (SE); Juan-Antonio Ibanez, Solna (SE); Marina Petrova, Aachen (DE); Jens Zander, Upplands-Väsby (SE)

(21) Appl. No.: 17/631,059

(22) PCT Filed: Oct. 29, 2020
(86) PCT No.: PCT/EP2020/080441

§ 371 Date: Jan. 28, 2022

Related U.S. Application Data
(60) Provisional application No. 62/927,440, filed on Oct. 29, 2019.

(51) Int. Cl. H04L 41/0895; H04L 41/5009; H04L 41/5019; H04L 43/0829; H04W 28/24

(52) U.S. Cl. CPC H04L 41/0895; H04L 41/5009; H04L 41/5019; H04L 43/0829; H04W 28/24

(57) ABSTRACT

Embodiments include methods for a network node in a wireless network to manage network resources. Such methods include mapping one or more application-level performance requirements to one or more network performance requirements. The mapping can be based on a Markov chain model and the application-level performance requirements can be associated with an application hosted by one or more user equipment (UEs) served by the wireless network. Such methods include, based on the network performance requirements, configuring at least one of the following for data transmission and/or reception associated with the application: the one or more UEs, and respective serving cells for the one or more UEs. Other embodiments include operations such as mapping one or more network performance parameters to one or more application-level performance metrics based on a Markov chain model, and monitoring whether the application-level performance metrics fulfill corresponding application-level performance requirements. Other embodiments include network nodes. FIG. 12 is selected for publication.

### TECHNICAL FIELD

The present invention generally relates to wireless networks, and particularly relates to techniques for mapping between application-level performance requirements or metrics (e.g., for cyber-physical control applications) and network- or radio-level performance requirements or parameters in a wireless network supporting such applications.

### BACKGROUND

The manufacturing industry is currently undergoing a fundamental change, which is often referred to as the “Fourth Industrial Revolution” or simply “Industry 4.0.” Goals of Industry 4.0 include improvement of flexibility, versatility, resource efficiency, cost efficiency, worker support, and quality of industrial production and logistics. These improvements are important for addressing the needs of increasingly volatile and globalized markets. A major enabler for these improvements is cyber-physical production systems based on a ubiquitous and powerful connectivity, communication, and computing infrastructure. This infrastructure should interconnect people, machines, products, and all kinds of other devices in a flexible, secure and consistent manner. For example, workers in the factories of Industry 4.0 are equipped with and/or supported by mobile devices.

There are several different application areas envisioned for Industry 4.0. For example, factory automation can involve the automated control, monitoring and optimization of processes and workflows within a factory. This includes aspects like closed-loop control applications (e.g., based on programmable logic or motion controllers) and robotics, as well as aspects of computer-integrated manufacturing. Factory automation generally represents a key enabler for industrial mass production with high quality and cost-efficiency. Corresponding applications are often characterized by the highest requirements on the underlying communication infrastructure, especially in terms of communication service availability, determinism, and latency. In the Industry 4.0, static sequential production systems will be more and more replaced by novel modular production systems offering a high flexibility and versatility. This involves many increasingly mobile production assets, for which powerful wireless communication and localization services are required.

As another example, process automation can involve the control of production and handling of substances like chemicals, food and beverages, pulp, etc. Process automation can improve the efficiency of production processes, energy consumption, and safety of the facilities. Sensors measuring process values, such as pressures or temperatures, are working in closed loops via centralized and decentralized controllers. In turn, the controllers interact with actuators such as valves, pumps, heaters, etc. Also, monitoring of attributes such as the filling levels of tanks, quality of material, or environmental data are important, as well as safety warnings or plant shutdowns. A process automation facility may range from a few hundred square meters to several square kilometers, and the facility may also be geographically distributed. Depending on the size, a production plant may have tens of thousands of measurement points and actuators. Device energy supply should be self-sufficient for years in order to stay flexible and to keep the total costs of ownership low.

As another example, human-machine interfaces (HMIs) include all sorts of devices for the interaction between people and production facilities, such as panels attached to a machine or production line, laptops, tablet PCs, smartphones, etc. In addition, augmented- and virtual-reality applications are expected to play an important role in Industry 4.0.

As another example, logistics and warehousing involve the organization and control of the flow and storage of materials and goods in the context of industrial production. Intra-logistics deals with logistics within a certain property (e.g., within a factory) by ensuring the uninterrupted supply of raw materials on the shop floor level using automated guided vehicles (AGVs), forklifts, etc. This is different from logistics between different sites. Warehousing involves the storage of materials and goods using conveyors, cranes, storage and retrieval systems, etc., any of which can be automated.

As another example, there is a need for monitoring and/or maintenance of various processes and/or assets used in industrial production without an immediate impact on the processes and/or assets. These applications are different from a typical closed-loop control system in factory automation. Such monitoring and/or maintenance includes applications such as condition monitoring and predictive maintenance based on sensor data, “big data” analytics for optimizing future parameter sets of processes, etc. For these use cases, the data acquisition process is necessary but typically not latency-critical.

It is expected that fifth-generation (5G) wireless networks (e.g., as standardized by 3GPP) will provide a significant portion of the connectivity and communication infrastructure needed for Industry 4.0 application areas (also referred to as “vertical domains”) including those discussed above. In general, a “vertical domain” is a particular industry or group of enterprises in which similar products or services are developed, produced, and provided. In order to be suitable for various vertical domains, 5G networks need to be dependable, flexible, and meet specific key performance indicators (KPIs) associated with particular applications and use cases. 5G networks must maintain properties of reliability, availability, maintainability, safety, and integrity. Particular requirements for each of these properties depends on the specific vertical domain and, in some instances, a specific use case within the domain.

3GPP TS 22.104 (v17.1.0) provides normative service requirements for 5G networks in the context of cyber-physical control applications in various vertical domains, including the exemplary application areas summarized above. As used in 3GPP TS 22.104 and herein, “cyber-physical systems” refers to systems that include engineered, interacting networks of physical and computational components. Likewise, “control applications” refers to applications that control physical processes.

Building on these definitions, “cyber-physical control applications” refers to applications that control physical processes by interacting with the physical environment (e.g., within a factory). For example, cyber-physical control applications in automation follow certain activity patterns, which can be open-loop control, closed-loop control, sequence control, and batch control. In addition to the application areas or vertical domains discussed above, other examples of cyber-physical control applications include remote surgery and electric power distribution.

In general, cyber-physical control applications place strict requirements on service availability, reliability, survival time (e.g., maximum number of lost packets tolerated without failure), and (in some cases) end-to-end (E2E) guaranteed latency. These requirements and/or performance metrics are generally defined in terms of parameters that are observable at the application layer. However, there is a need to map these requirements into parameters associated with lower communication layers in the network, such as the physical layer (PHY), medium access control layer (MAC), etc. For example, application requirements need to be translated into PHY requirements for a transmitter to activate specific techniques (such as retransmissions and repetition coding) at specific times.

Certain techniques for mapping service (or application layer) requirements into network parameters have been proposed. However, these proposed techniques suffer from various drawbacks that make them unsuitable for realistic conditions experienced by cyber-physical control applications, including realistic wireless channel conditions and realistic survival times.

### SUMMARY

Embodiments of the present disclosure provide specific improvements to communication between user equipment (UE) and network nodes in a wireless communication network, such as by facilitating solutions to overcome the exemplary problems summarized above and described in more detail below. For example, embodiments provide flexible and efficient mapping between application and network performance, which facilitates configuring network parameters for, and/or monitoring network compliance with, application-layer performance requirements.

Some embodiments of the present disclosure include methods (e.g., procedures) for managing network resources in a wireless network. These exemplary methods can be performed by a network node (e.g., base station, eNB, gNB, gNB-CU, AMF, UPF, etc., or components thereof) in the wireless network (e.g., a 5G network).

These exemplary methods can include mapping one or more application-level performance requirements to one or more network performance requirements. The mapping can be performed based on a Markov chain model, and the application-level performance requirements can be associated with an application hosted by one or more UEs served by the wireless network. These exemplary methods can also include, based on the network performance requirements, configuring at least one of the following for data transmission and/or reception associated with the application: the one or more UEs, and respective serving cells for the one or more UEs. The respective serving cells can be provided by the network node itself or by a further network node in the wireless network. The one or more UEs can be served by a single cell or different cells.

In some embodiments, these exemplary methods can also include receiving the application-level performance requirements from an application server (e.g., an application function, AF) associated with the application. In various embodiments, the application-level performance requirements can include any of the following:
Availability (A) of the application according to a predetermined quality of service;
Reliability (R) relating to a mean time between application outages; and
Survival time (N_sv) relating to a maximum number of consecutive lost packets that will not cause an application outage.
   In some embodiments, the mapping can be based on three parameters associated with the application-level performance requirements.

In various embodiments, the network performance requirements can include any of the following:
Mean time to repair (τ̅_{TR}) relating to an average number of consecutive packet losses;
Mean time between failure (τ̅_{BF}) relating to an average number of consecutive successfully-received packets; and
Packet error rate (PER).

In some embodiments, the Markov chain model can comprise a state space partitioned into Nₛᵥ+2 states, [symbol] ={ [symbol] _{N}, 1, 2, . . . , [symbol] ₛᵥ, [symbol] }, where Nₛᵥ is a survival time of the application, state [symbol] _{N} represents a time that the wireless network is available, and state [symbol] represents a time that application becomes unavailable after Nₛᵥ consecutive packet failure events. In some embodiments, the Markov chain model can also include a state transition matrix, M, having entries that are based on the following network performance requirements: a mean time to repair, τ̅_{TR}, relating to an average number of consecutive packet losses and a mean time between failure, τ̅_{BF}, relating to an average number of consecutive successfully transmitted packets.

In some embodiments, the application can be a cyber-physical control application, the wireless network can be a 5G network, and the network node can be one of the following: a base station (gNB) or component thereof; an access and mobility management function (AMF); or a user plane function (UPF).

In some embodiments, the configuring operations can include selecting one or more first techniques for reliability enhancement (TREs) needed to meet the network performance requirements; and configuring at least one of the following to use the first TREs when transmitting and/or receiving data associated with the application: the one or more UEs, and respective serving cells for the one or more UEs. In various embodiments, the one or more first TREs can include any of the following:
increased transmission power;
carrier aggregation;
dual connectivity;
data message repetition;
link adaptation based on modulation and coding scheme (MCS);
multi-antenna transmission and/or reception;
MAC-layer multiplexing and/or retransmission;
RLC-layer retransmission; and
PDCP-layer duplication.

In some embodiments, these exemplary methods can also include, during the transmission and/or reception of the data associated with the application, determining one or more network performance parameters; and, based on determining that the one or more network performance parameters do not fulfill the mapped one or more network performance requirements, selecting one or more second TREs needed to meet the network performance requirements. The second TREs can include any of the first TREs, summarized above. Alternately, if the first TREs were provided during the configuring operation, at least some of the second TREs can be different than the first TREs. In some embodiments, these exemplary methods can also include configuring at least one of the following to use the second TREs when transmitting and/or receiving subsequent data associated with the application: the one or more UEs, and the respective serving cells for the one or more UEs.

In some embodiments, these exemplary methods can also include various operations related to monitoring one or more network performance parameters during the transmission and/or reception of the data associated with the application, and configuring (as determined to be necessary) at least one of the following to use second TREs when transmitting and/or receiving subsequent data associated with the application: the one or more UEs, and the respective serving cells for the one or more UEs. For example, if the first TREs were provided during the initial configuring operation, at least some of the second TREs can be different than the first TREs.

Other embodiments of the present disclosure include additional methods (e.g., procedures) for managing network resources in a wireless network. These exemplary methods can be performed by a network node (e.g., base station, eNB, gNB, gNB-CU, AMF, UPF, etc., or components thereof) in the wireless network (e.g., a 5G network).

These exemplary methods can include mapping one or more network performance parameters to one or more application-level performance metrics. The mapping can be performed based on a Markov chain model, the application-level performance metrics can be associated with an application hosted by one or more UEs served by the wireless network, and the network performance parameters can represent performance of the wireless network during transmission and/or reception of data associated with the application. These exemplary methods can also include monitoring whether the application-level performance metrics fulfill corresponding one or more application-level performance requirements associated with the application. In some embodiments, the network node can perform the monitoring in relation to a service level agreement (SLA).

In some embodiments, these exemplary methods can also include receiving the application-level performance requirements from an application server (e.g., an application function, AF) associated with the application. In various embodiments, the application-level performance metrics can include any of the following:
Availability (A) of the application according to a predetermined quality of service;
Reliability (R) relating to a mean time between application outages; and
Survival time (N_sv) relating to a maximum number of consecutive lost packets.

In various embodiments, the network performance parameters can include any of the following:
Mean time to repair (τ̅_{TR}) relating to an average number of consecutive packet losses;
Mean time between failure (τ̅_{BF}) relating to an average number of consecutive successfully-received packets; and
Packet error rate (PER).
   In some embodiments, the mapping can be based on two network performance parameters.

In various embodiments, the Markov chain model can have any of the characteristics summarized above in relation to other embodiments. In some embodiments, the application can be a cyber-physical control application, the wireless network can be a 5G network, and the network node can be one of the following: a base station (gNB) or component thereof; an access and mobility management function (AMF); or a user plane function (UPF).

Other embodiments include network nodes (e.g., base stations, eNBs, gNBs, ng-eNBs, MMEs, AMFs, UPFs, etc. or components thereof) configured to perform operations corresponding to any of the exemplary methods described herein. Other exemplary embodiments include non-transitory, computer-readable media storing program instructions that, when executed by processing circuitry, configure such network nodes to perform operations corresponding to any of the exemplary methods described herein.

These and other objects, features, and advantages of the present disclosure will become apparent upon reading the following Detailed Description in view of the Drawings briefly described below.

### BRIEF DESCRIPTION OF THE DRAWINGS

FIGS. 1A-1D illustrate various configurations of slots usable for 5G “New Radio” (NR) operation.

FIGS. 2-3 show two high-level views of an exemplary 5G network architecture.

FIG. 4 illustrates an exemplary system model for industry automation applications.

FIG. 5 shows an example of how application-level performance can differ from network-level performance.

FIG. 6 illustrates a high-level mapping function between network-level parameters (or metrices) and application-level requirements or metrices, according to various exemplary embodiments of the present disclosure.

FIG. 7 illustrates a more detailed variant of the high-level mapping function shown in FIG. 6, according to various exemplary embodiments of the present disclosure.

FIG. 8 shows an exemplary technique for mapping application-level requirements to different network layers using a Markov chain, according to various exemplary embodiments of the present disclosure.

FIGS. 9A and 9B are graphs illustrating the impacts of survival time on application-level availability and reliability requirements, respectively, according to various exemplary embodiments of the present disclosure.

FIGS. 10A and 10B are graphs illustrating the impacts of mean time to repair (MTTR) on application-level availability and reliability requirements, respectively, according to various exemplary embodiments of the present disclosure.

FIGS. 11-13 are flow diagrams of exemplary methods (e.g., procedures) for a network node (e.g., base station, eNB, gNB, ng-eNB, gNB-CU, MME, AMF, UPF, SMF etc. or component thereof) in a wireless network, according to various exemplary embodiments of the present disclosure.

FIG. 14 illustrates an exemplary wireless network, according to various exemplary embodiments of the present disclosure.

FIG. 15 illustrates an exemplary UE, according to various exemplary embodiments of the present disclosure.

FIG. 16 is a block diagram illustrating an exemplary virtualization environment usable for implementing various exemplary embodiments of the present disclosure.

FIGS. 17-18 are block diagrams of exemplary communication systems and/or networks, according to various exemplary embodiments of the present disclosure.

FIGS. 19-22 are flow diagrams illustrating exemplary methods (e.g., procedures) implemented in a communication system, according to various exemplary embodiments of the present disclosure.

### DETAILED DESCRIPTION

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features, and advantages of the enclosed embodiments will be apparent from the following description.

Furthermore, the following terms are used throughout the description given below:
Radio Node: As used herein, a “radio node” can be either a “radio access node” or a “wireless device.”
Radio Access Node: As used herein, a “radio access node” (or equivalently “radio network node,” “radio access network node,” or “RAN node”) can be any node in a radio access network (RAN) of a cellular communications network that operates to wirelessly transmit and/or receive signals. Some examples of a radio access node include, but are not limited to, a base station (e.g., a New Radio (NR) base station (gNB) in a 3GPP Fifth Generation (5G) NR network or an enhanced or evolved Node B (eNB) in a 3GPP LTE network), base station distributed components (e.g., CU and DU), a high-power or macro base station, a low-power base station (e.g., micro, pico, femto, or home base station, or the like), an integrated access backhaul (IAB) node, a transmission point, a remote radio unit (RRU or RRH), and a relay node.
Core Network Node: As used herein, a “core network node” is any type of node in a core network. Some examples of a core network node include, e.g., a Mobility Management Entity (MME), a serving gateway (SGW), a Packet Data Network Gateway (P-GW), an access and mobility management function (AMF), a session management function (AMF), a user plane function (UPF), a Service Capability Exposure Function (SCEF), or the like.
Wireless Device: As used herein, a “wireless device” (or “WD” for short) is any type of device that has access to (i.e., is served by) a cellular communications network by communicating wirelessly with network nodes and/or other wireless devices. Communicating wirelessly can involve transmitting and/or receiving wireless signals using electromagnetic waves, radio waves, infrared waves, and/or other types of signals suitable for conveying information through air. Unless otherwise noted, the term “wireless device” is used interchangeably herein with “user equipment” (or “UE” for short). Some examples of a wireless device include, but are not limited to, smart phones, mobile phones, cell phones, voice over IP (VoIP) phones, wireless local loop phones, desktop computers, personal digital assistants (PDAs), wireless cameras, gaming consoles or devices, music storage devices, playback appliances, wearable devices, wireless endpoints, mobile stations, tablets, laptops, laptop-embedded equipment (LEE), laptop-mounted equipment (LME), smart devices, wireless customer-premise equipment (CPE), mobile-type communication (MTC) devices, Internet-of-Things (IoT) devices, vehicle-mounted wireless terminal devices, etc.
Network Node: As used herein, a “network node” is any node that is either part of the radio access network (e.g., a radio access node or equivalent name discussed above) or of the core network (e.g., a core network node discussed above) of a cellular communications network. Functionally, a network node is equipment capable, configured, arranged, and/or operable to communicate directly or indirectly with a wireless device and/or with other network nodes or equipment in the cellular communications network, to enable and/or provide wireless access to the wireless device, and/or to perform other functions (e.g., administration) in the cellular communications network.

Note that the description given herein focuses on a 3GPP cellular communications system and, as such, 3GPP terminology or terminology similar to 3GPP terminology is oftentimes used. However, the concepts disclosed herein are not limited to a 3GPP system. Furthermore, although the term “cell” is used herein, it should be understood that (particularly with respect to 5G NR) beams may be used instead of cells and, as such, concepts described herein apply equally to both cells and beams.

While fourth-generation (4G, also known as “LTE”) networks were primarily designed for user-to-user communications, 5G (also referred to as “NR”) networks are envisioned to support both high single-user data rates (e.g., 1 Gb/s) and large-scale, machine-to-machine communication involving short, bursty transmissions from many different devices that share the frequency bandwidth. The 5G radio standards (also referred to as “New Radio” or “NR”) are currently targeting a wide range of data services including eMBB (enhanced Mobile Broad Band), URLLC (Ultra-Reliable Low Latency Communication), and Machine-Type Communications (MTC). These services can have different requirements and objectives.

For example, URLLC is intended to provide a data service with extremely strict error and latency requirements, e.g., error probabilities as low as 10⁻⁵ or lower and 1 ms end-to-end latency or lower. However, the peak data rate requirements are moderate. For eMBB, the latency and error probability requirements can be less stringent than URLLC, whereas the required peak rate and/or spectral efficiency can be higher than URLLC. In addition, NR is targeted to support deployment in lower-frequency spectrum similar to LTE, and in very-high-frequency spectrum (referred to as “millimeter wave” or “mmW”).

Similar to LTE, NR uses orthogonal frequency division multiplexing (OFDM) in the downlink. Each NR radio frame is 10 ms in duration and is composed of 10 subframes having equal durations of 1 ms each. Each subframe consists of one or more slots, and each slot consists of 14 (for normal cyclic prefix) or 12 (for extended cyclic prefix) time-domain symbols.

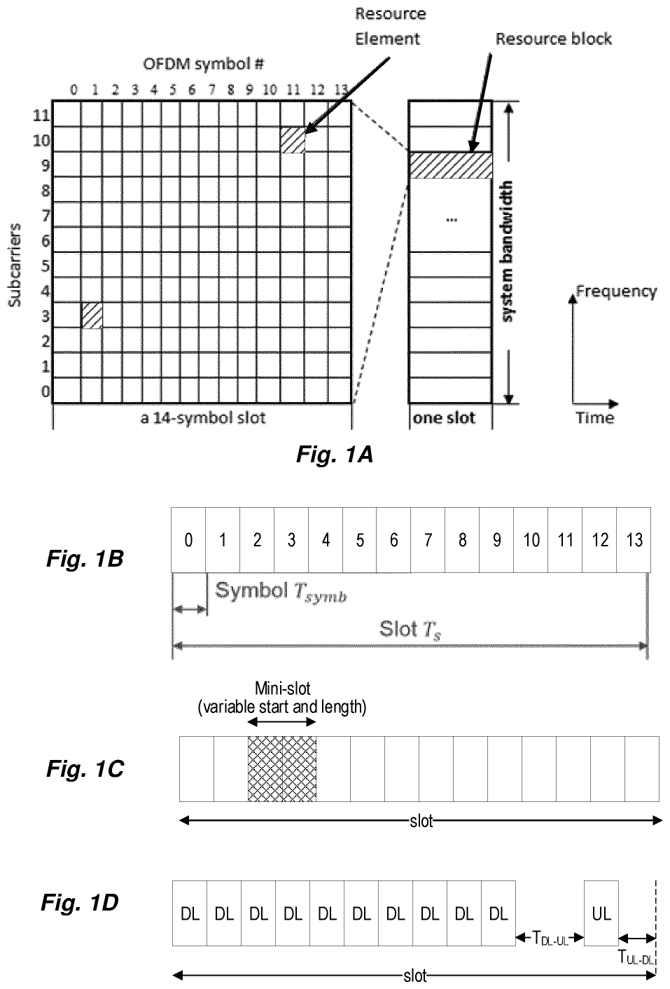

FIG. 1A shows an exemplary time-frequency resource grid for an NR slot. As illustrated in FIG. 1A, a resource block (RB) consists of 12 contiguous, or consecutive, subcarriers in the frequency domain. In this example, the RB spans 14 symbols in the time domain for a duration of a 14-symbol slot, but in other examples may span a different number of symbols. Like in LTE, a resource element (RE) consists of one subcarrier in the frequency domain and one symbol in the time domain. Common RBs (CRBs) are numbered from 0 to the end of the system bandwidth. Each bandwidth part (BWP) configured for a UE has a common reference of CRB 0, such that a particular configured BWP may start at a CRB greater than zero. In this manner, a UE can be configured with a narrow BWP (e.g., 10 MHz) and a wide BWP (e.g., 100 MHz), each starting at a particular CRB, but only one BWP can be active for the UE in UL and DL at any given time.

FIG. 1B shows an exemplary NR slot configuration comprising 14 symbols, where the slot and symbol durations are denoted Tₛ and T_{symb}, respectively. The NR PHY also allows mini-slot transmissions. A mini-slot can include from one symbol up to one less than the number of symbols in a slot and can start at any symbol within a slot. FIG. 1C shows an exemplary mini-slot arrangement in which the mini-slot begins in the third symbol of the slot and is two symbols in duration. An NR slot can also be arranged with various combinations of UL and DL symbols. FIG. 1D shows an exemplary “DL-heavy” slot with one UL symbol. Moreover, this exemplary slot format includes guard periods before and after the UL symbol to facilitate change of transmission direction.

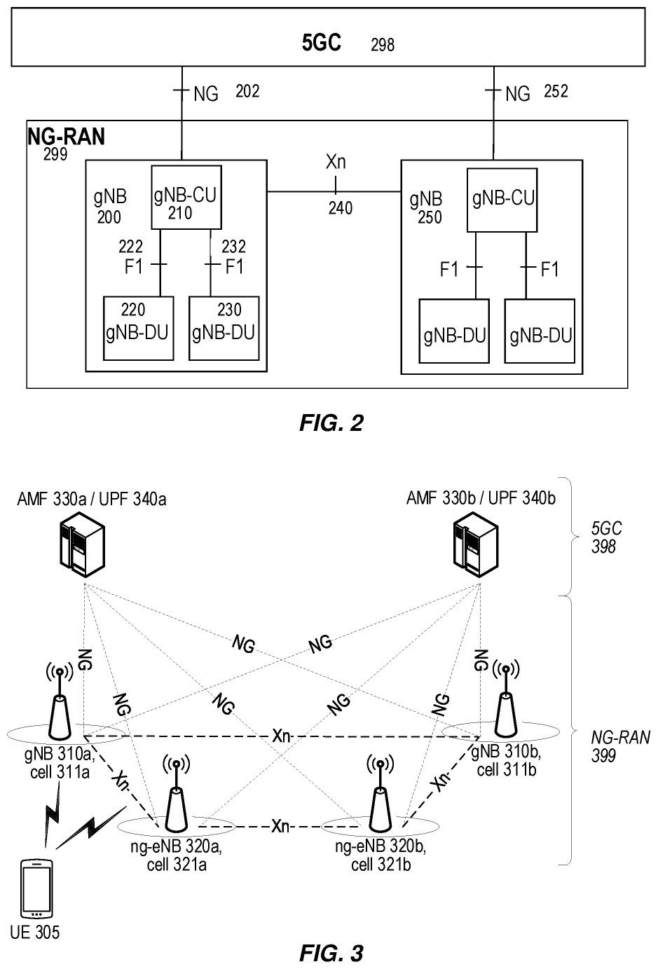

FIG. 2 illustrates a high-level view of the 5G network architecture, consisting of a Next Generation RAN (NG-RAN) 299 and a 5G Core (5GC) 298. NG-RAN 299 can include a set gNBs connected to the 5GC via one or more NG interfaces, such as gNBs 200, 250 connected via interfaces 202, 252, respectively. In addition, the gNBs can be connected to each other via one or more Xn interfaces, such as Xn interface 240 between gNBs 200 and 250.

NG-RAN 299 is layered into a Radio Network Layer (RNL) and a Transport Network Layer (TNL). The NG-RAN architecture, i.e., the NG-RAN logical nodes and interfaces between them, is defined as part of the RNL. For each NG-RAN interface (NG, Xn, F1) the related TNL protocol and the functionality are specified. The TNL provides services for user plane transport and signaling transport. In some exemplary configurations, each gNB can be connected to all 5GC nodes within an “AMF Region,” which is defined in 3GPP TS 23.501 (e.g. v16.2.0). If security protection for CP and UP data on the TNL of NG-RAN interfaces is supported, NDS/IP (e.g., as defined in 3GPP TS 33.401 (e.g. v16.0.0)) can be applied.

The NG-RAN logical nodes shown in FIG. 2 include a central (or centralized) unit (CU or gNB-CU) and one or more distributed (or decentralized) units (DU or gNB-DU). Such an architecture is described in 3GPP TS 38.401 (e.g. v15.6.0) and TR 38.801 (e.g. v14.0.0). For example, gNB 200 includes gNB-CU 210 and gNB-DUs 220 and 230. CUs (e.g., gNB-CU 210) are logical nodes that host higher-layer protocols and perform various gNB functions such controlling the operation of DUs. Likewise, each DU is a logical node that hosts lower-layer protocols and can include various subsets of the gNB functions, depending on the functional split. As such, each of the CUs and DUs can include various circuitry needed to perform their respective functions, including processing circuitry, transceiver circuitry (e.g., for communication), and power supply circuitry. Moreover, the terms “central unit” and “centralized unit” are used interchangeably herein, as are the terms “distributed unit” and “decentralized unit.”

A gNB-CU connects to gNB-DUs over respective F1 logical interfaces, such as interfaces 222 and 232. The gNB-CU and connected gNB-DUs are only visible to other gNBs and 5GC 298 as a gNB. In other words, the F1 interface is generally not visible beyond a gNB-CU.

FIG. 3 shows a high-level view of an exemplary 5G network architecture, including NG-RAN 399 and 5GC 398. As shown in the figure, NG-RAN 399 can include gNBs 310 (e.g., 310a,b) and ng-eNBs 320 (e.g., 320a,b) that are interconnected with each other via respective Xn interfaces. The gNBs and ng-eNBs are also connected via the NG interfaces to 5GC 398, more specifically to the AMF (Access and Mobility Management Function) 330 (e.g., AMFs 330a,b) via respective NG-C interfaces and to the UPF (User Plane Function) 340 (e.g., UPFs 340a,b) via respective NG-U interfaces.

Each of the gNBs 310 can support the NR radio interface including frequency division duplexing (FDD), time division duplexing (TDD), or a combination thereof. In contrast, each of ng-eNBs 320 can support the LTE radio interface but, unlike conventional LTE eNBs (such as shown in FIG. 1), connect to the 5GC via the NG interface. Each of the gNBs and ng-eNBs can serve a geographic coverage area including one more cells, including cells 311a-b and 321a-b shown as exemplary in FIG. 3. As mentioned above, the gNBs and ng-eNBs can also use various directional beams to provide coverage in the respective cells. Depending on the particular cell in which it is located, a UE 305 can communicate with the gNB or ng-eNB serving that particular cell via the NR or LTE radio interface, respectively.

Each of the gNBs 310 may include and/or be associated with a plurality of Transmission Reception Points (TRPs). Each TRP is typically an antenna array with one or more antenna elements and is located at a specific geographical location. In this manner, a gNB associated with multiple TRPs can transmit the same or different signals from each of the TRPs. For example, a gNB can transmit different version of the same signal on multiple TRPs to a single UE. Each of the TRPs can also employ beams for transmission and reception towards the UEs served by the gNB, as discussed above.

As briefly mentioned above, certain techniques for mapping service (or application layer) requirements into network parameters have been proposed. However, these existing techniques suffer from various drawbacks that make them unsuitable for realistic conditions experienced by cyber-physical control applications, including realistic wireless channel conditions and realistic survival time. This is discussed in more detail below, using certain terms that are defined as follows (e.g., based on 3GPP TS 22.104 v17.1.0):
Packet loss: an event in which a protocol data unit (PDU) is not successfully delivered within a specified deadline to the target PDU layer (e.g., UPF).
Survival time (Tₛᵥ): the time that an application consuming a communication service may continue without an anticipated message. For periodic traffic, with cycle time T_{c}, survival time can be expressed as maximum number of lost packets (denoted here as Nₛᵥ, where

$${N}_{s v} = ⌊ \frac{{T}_{s v}}{T c} ⌋ )$$

that the application can tolerate without failure.
Application level availability (A): percentage value of the amount of time the end-to-end communication service is delivered according to an agreed QoS as observed by the application layer, divided by the amount of time the system is expected to deliver the end-to-end service according to the specification in a specific area. Note that the application can tolerate Nₛᵥ consecutive packet loss and still be available.
Application level unavailability: percentage value of the amount of time the end-to-end communication service does not fulfil the agreed QoS as observed by the application layer, divided by the amount of time the system is expected to deliver the end-to-end service according to the specification in a specific area. In other words, application level unavailability is 1−A.
Application level reliability (R): ability of the communication service to perform as required for application layer for a given time interval, under given conditions. Mean time between failures is one of the typical indicators of reliability. This parameter states the mean value of how long the application is available before it becomes unavailable. Note that a failure in application happens after N consecutive packet loss.
Network level availability (A_{N}): percentage value of the amount of time the communication service is able to deliver according to an agreed QoS as observed by network, divided by the amount of time the system is expected to deliver the end-to-end service according to the specification in a specific area. Note that the first packet loss makes the network unavailable. Assuming periodic traffic, it can be shown that

A_{N}=1−p=1−E[PER],
where p is the packet error probability which is the expected value of packet error rate (PER). The definitions of p and PER can be found in [2].
Network reliability (τ̅_{BF}): mean time between packet failures (MTBF) which states the mean value of how long the network is available before it becomes unavailable.
Mean time to repair (MTTR or τ̅_{TR}): mean value of how long the network is unavailable before it becomes available again (sometimes it is referred to as mean down time of the network or average burst error length). MTTR can be derived from p and network reliability (τ̅_{BF}) as:

τ̅_{TR}=(τ̅_{BF}×p)/(1−p).
Techniques for communication layer Reliability Enhancement (TRE). Typically, UEs or network nodes have several TREs available in different network communication layers. Example TREs include carrier aggregation (CA), dual connectivity (DC), multi-antenna techniques (e.g., spatial diversity, MIMO, etc.), message repetition (e.g., with different redundancy version, RV), link adaptation (e.g., selecting a different modulation and coding scheme, MCS), MAC multiplexing, MAC retransmission, radio link control layer (RLC) retransmission, and packet data convergence protocol layer (PDCP) duplication. Turning ON all of such techniques for every UE and every traffic within the UE and among UEs can be costly for both the UEs and the network, e.g., in terms of bandwidth or network capacity, computational resources, spectral efficiency, etc. TREs should only be used as needed and/or required.

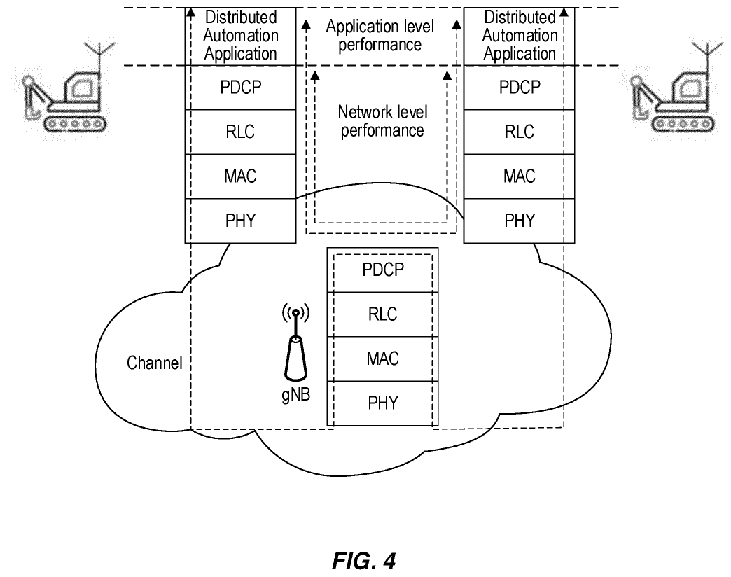

FIG. 4 illustrates an exemplary system model for industry automation applications. In particular, FIG. 4 shows a distributed automation scenario involving two machines, each running a distributed automation application on top of a protocol stack used for communication to a 5G network, e.g., via a radio channel to a gNB serving a cell. As shown in FIG. 4, performance metrics such as reliability and availability can be measured based on observations on either the application layer or the network layer. Currently, the requirements for such applications are defined on application layer, and it is unclear how to translate these into network level performance of the underlying 5G system.

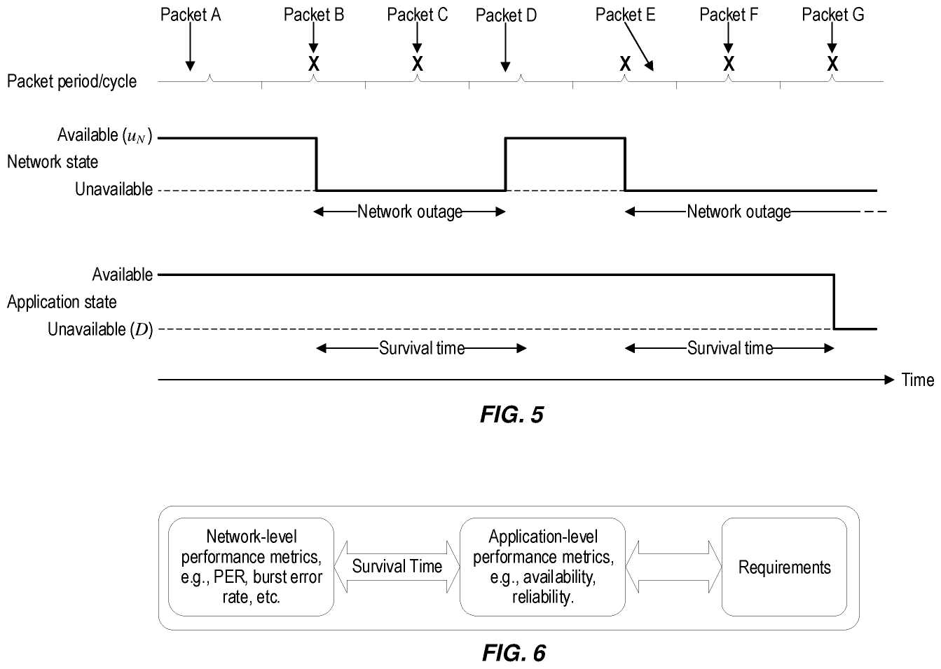

FIG. 5 shows an example on how application-level performance can differ from network-level performance. In particular, FIG. 5 shows availability timelines at the network level and the application level at the top and bottom, respectively. The top timeline shows that the network is deemed unavailable after losses of packets B, C, E, F, and G, but otherwise available. On the other hand, the bottom timeline shows that the application remains available even during the losses of packets B and C due to its associated survival time. However, the application becomes unavailable after three consecutive packet losses (E-G), because the time since the last successfully-received packet exceeds the survival time.

As such, there is a need for mapping application-level performance requirements (e.g., availability and reliability) to network performance requirements such as packet error rate (PER), MTTR, etc. Additionally or alternately, there is a need for mapping network performance parameters (e.g., PER, MTTR, etc.) to application-level performance metrics (e.g., availability and reliability). Alternatively or additionally, there is a need for mapping application-level performance metrics (e.g., availability and reliability) to requirements one network parameters such as packet error rate (PER), MTTR, etc. 3GPP TDoc S1-183134 proposed one technique for mapping of application layer requirements into network parameters for the case of independent packet failures. However, this proposal does not address the more realistic channel condition where packet failures are non-independent (e.g., correlated, due to fading). Other proposals assume a unique observation between application and network performance, such that there is no survival time on the application layer.

As explained in 3GPP TS 22.104 (e.g. v16.2.0), the concept of survival time applies to most cyber-physical control applications. For example, consider an application in which new positions are sent periodically to mobile robots. In this case, having limited number of consecutive packet losses (e.g., packets B-C in FIG. 5) will not impact the overall availability of the robot during this time period. In other words, when a new packet is successfully received, the application layer can use various methods, such as interpolation, to estimate the lost positions.

Accordingly, exemplary embodiments of the present disclosure provide novel, flexible, and efficient techniques for mapping between application layer performance metrics or requirements (e.g., survival time, availability, reliability, etc.) and network performance parameters (PER, etc.) using a Markov chain. Such embodiments enable a UE or a network node to easily, quickly, and accurately obtain the network layer requirements from application layer requirements and to initiate any TREs necessary to remain in compliance with such requirements, while avoiding TREs that unnecessarily increase the burden on network resources. Furthermore, the use of a Markov chain model improves mapping accuracy since it accounts for more realistic effects of channel conditions on application-layer performance.

Other embodiments enable a network to monitor its fulfillment of the application layer requirements during operation (e.g., while transmitting/receiving data associated with the application). This can be done, for example, by mapping network performance parameters or metrics (e.g., associated with transmission/reception of application data) to application-level performance metrics using the Markov chain model.

In general, a Markov chain is a mathematical model (e.g., of a physical system) including a plurality of states (referred to as the “state space”) in which transitions between states occur according to certain probabilistic (e.g., stochastic or non-deterministic) rules. One characteristic of a Markov chain is that no matter how the modeled process arrived at its present state, the possible future states are fixed. In other words, the probability of transitioning to any particular state is dependent solely on the current state and time elapsed. In other words, a Markov chain is “memory-less” in that future states are not dependent upon the steps that led to the present state.

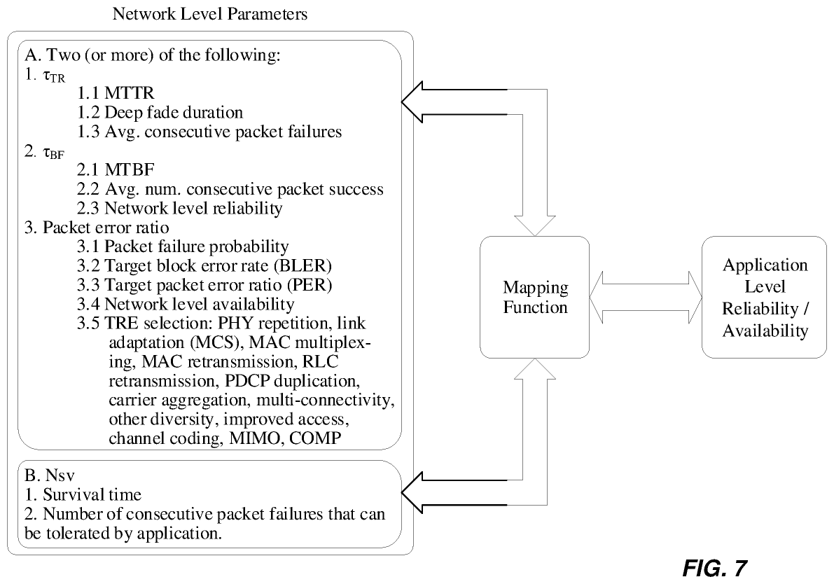

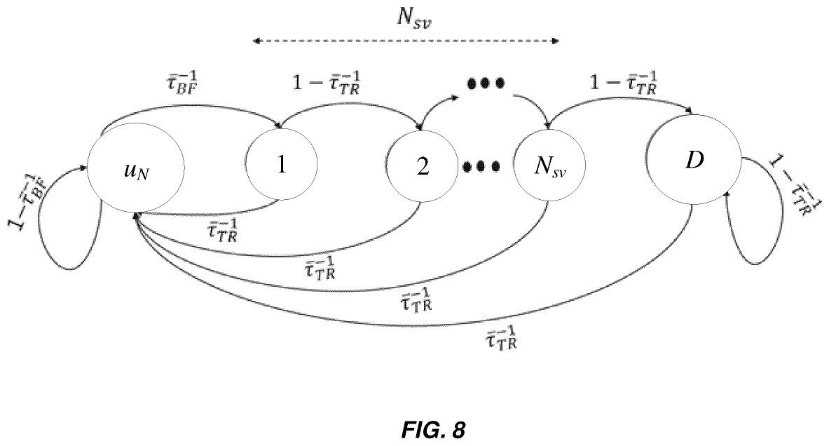

FIG. 6 illustrates (at a high level) a two-way mapping between network-level performance metrics and application-level requirements. FIG. 7 illustrates a more detailed variant of the high-level mapping arrangement shown in FIG. 6, according to various exemplary embodiments of the present disclosure. In particular, the variant shown in FIG. 7 illustrates a two-way mapping between various network performance parameters packet failure probability (p), reliability (or mean time between failures) τ̅_{BF}, and mean time to repair (MTTR or τ̅_{TR}) and application-level reliability (R) and availability (A) requirements. For example, the mapping function provides as output (or requires as input) two or more parameters from group “A” (i.e., two or more of A1, A2, and A3) and one parameter from group “B” (i.e., B1 or B2).

In some embodiments, the UE or the network node can determine a mapping to application-level availability (A) and reliability (R) based on the following relations:

$$A = 1 - \frac{{{\overline{τ}}_{B F}^{- 1} ( 1 - {\overline{τ}}_{T R}^{- 1} )}^{{N}_{s v}}}{{\overline{τ}}_{BF}^{- 1} + {\overline{τ}}_{T R}^{- 1}} = 1 - {p ( 1 - {\overline{τ}}_{T R}^{- 1} )}^{{N}_{s v}} , \qquad ( 1 )$$

$$R = \frac{{\overline{τ}}_{B F}^{- 1} + {\overline{τ}}_{T R}^{- 1}}{{\overline{τ}}_{BR}^{- 1} {{\overline{τ}}_{TR}^{- 1} ( 1 - {\overline{τ}}_{TR}^{- 1} )}^{{N}_{s v}}} - {\overline{τ}}_{T R} = \frac{1}{p {{\overline{τ}}_{TR}^{- 1} ( 1 - {\overline{τ}}_{TR}^{- 1} )}^{{N}_{s v}}} - {\overline{τ}}_{TR} , \qquad ( 2 )$$

where Nₛᵥ is the number of consecutive packet failures that the application layer can tolerate while remaining available. The above relations can be rearranged mathematically to map from application-level availability (A) and reliability (R) to network-level packet failure probability (p), mean time to repair (τ̅_{TR}), and mean time between failures (τ̅_{BF}) according to:

$${\overline{τ}}_{T R} = R ( 1 - A ) / A , \qquad ( 3 )$$

$$p = ( 1 - A ) / {( 1 - \frac{A}{R ( 1 - A )} )}^{{N}_{s v}} \qquad ( 4 )$$

$${\overline{τ}}_{B F} = {\overline{τ}}_{T R} ( 1 - p ) / p . \qquad ( 5 )$$

In some embodiments, the UE or the network node can determine and/or apply the mapping function based on a Markov chain that tracks bursty failures with up to Nₛᵥ packets in each burst. FIG. 8 shows an exemplary technique using a Markov chain, according to these embodiments. As FIG. 8 illustrates, a state space is partitioned into Nₛᵥ+2 states as [symbol] ={ [symbol] _{N}, 1, 2, . . . , [symbol] ₛᵥ, [symbol] }. The first state, [symbol] _{N}, represents the time that network is available. While network is available, the first failure happens with the probability of τ̅_{BF}⁻¹. The Nₛᵥ middle states keep track of Nₛᵥ consecutive failed packets during which the application is still available (i.e., due to the application's survival time). The far-right state, [symbol] , represents the time that application becomes unavailable after Nₛᵥ consecutive packet failure events.

Since the above-described Markov chain is irreducible and aperiodic, it has a unique equilibrium distribution that can be derived by Markov properties using the transition probabilities shown in FIG. 8. The transition matrix, [symbol] , for the exemplary Markov chain is given by:

$$= ( \begin{matrix}1 - {\overline{τ}}_{B F}^{- 1} & {\overline{τ}}_{B F}^{- 1} & 0 & … & 0 \\ {\overline{τ}}_{TR}^{- 1} & 0 & 1 - {\overline{τ}}_{TR}^{- 1} & … & 0 \\ ⋮ & ⋮ & ⋮ & ⋱ & ⋮ \\ {\overline{τ}}_{TR}^{- 1} & 0 & 0 & … & 1 - {\overline{τ}}_{TR}^{- 1} \\ {\overline{τ}}_{TR}^{- 1} & 0 & 0 & … & 1 - {\overline{τ}}_{TR}^{- 1}\end{matrix} ) , \qquad ( 6 )$$

and according to Markov properties for steady state probabilities:

π̅× [symbol] =\vec{π}, (7)

Σᵢ₌₁^{N}^{ₛᵥ}⁺²πᵢ=1, (8)

where πᵢ denotes the steady state probability for ith state and \vec{π} denotes the vector containing all state probabilities.

All the steady state probabilities can be derived by solving the two equations above. In this case, the steady state probability of [symbol] _{N} is the network availability (A_{N}) which is equal to 1−p. Moreover, the steady-state probability of state [symbol] represents the application level unavailability (1−A), where the availability A is defined by equation (1), above. Furthermore, the application level reliability R can be derived as

$$R = \frac{1 -}{{L}_{z}} , \qquad ( 9 )$$

where π [symbol] represents the steady state probability for state [symbol] and L_{Z} denotes the mean number of transitions to state [symbol] per time unit. Accordingly, 1/L_{z} is the mean time to have two consecutive transitions to state [symbol] , and therefore, multiplying 1/L_{z} to the application level availability (1−π [symbol] ) results in the mean time period during which application is available.

The mean number of transitions to [symbol] , L_{Z}, can be derived as:

$${L}_{Z} = {sv}_{} ( 1 - {\overline{τ}}_{T R}^{- 1} ) = \frac{{{\overline{τ}}_{T R}^{- 1} ( 1 - {\overline{τ}}_{T R}^{- 1} )}^{{N}_{s v}} {\overline{τ}}_{B F}^{- 1}}{{\overline{τ}}_{B F}^{- 1} + {\overline{τ}}_{TR}^{- 1}} , \qquad ( 10 )$$

where π_{N}_{ₛᵥ} is the steady state probability for state [symbol] ₛᵥ shown in FIG. 8. Combining equations (9)-(10) results in the application level reliability R given by equation (2).

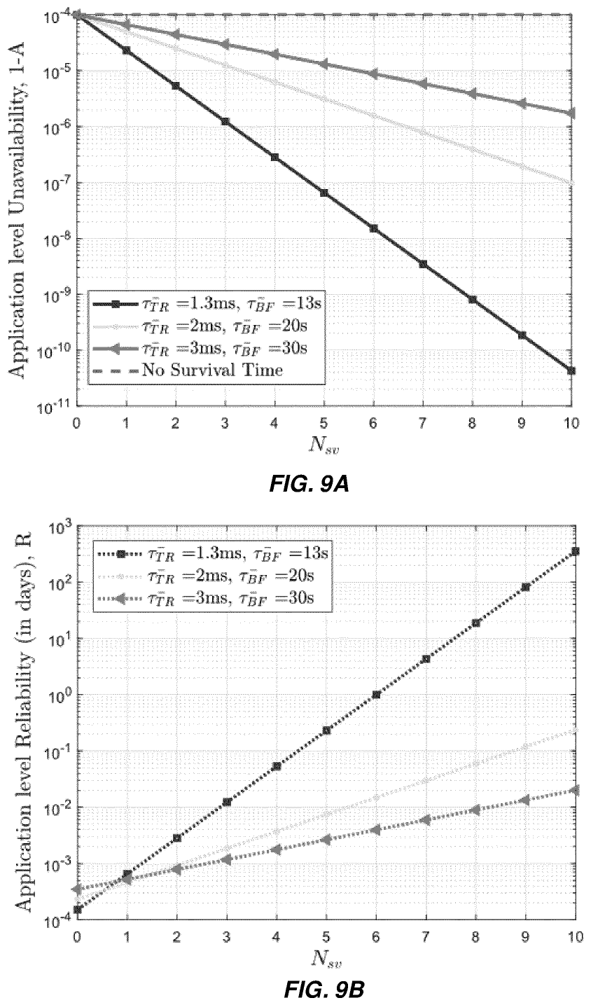

These embodiments can be further illustrated by particular examples. However, such examples should not be seen as limiting the scope of the embodiments of the present disclosure. In one example, application availability (A) and reliability (R) is based on the number of tolerable consecutive packet failures. For this example, cyclic traffic with 1 ms cycle time (T_{c}) and packet error probability (PER) of 10⁻⁴ are assumed. FIGS. 9A and 9B are graphs illustrating the impacts of survival time on application-level availability and reliability requirements, respectively, according to this example. More specifically, FIGS. 9A-B show that, based on mean time to repair (τ̅_{TR}) and mean time between failures (τ̅_{BF}) of 1.3 ms and 13 seconds for the network, respectively, an application availability (A) of eight nines (i.e., 99.999999%) and application reliability (R) of 1 day can be provided for bursty failures with survival time up to Nₛᵥ=6 packet failures in each burst.

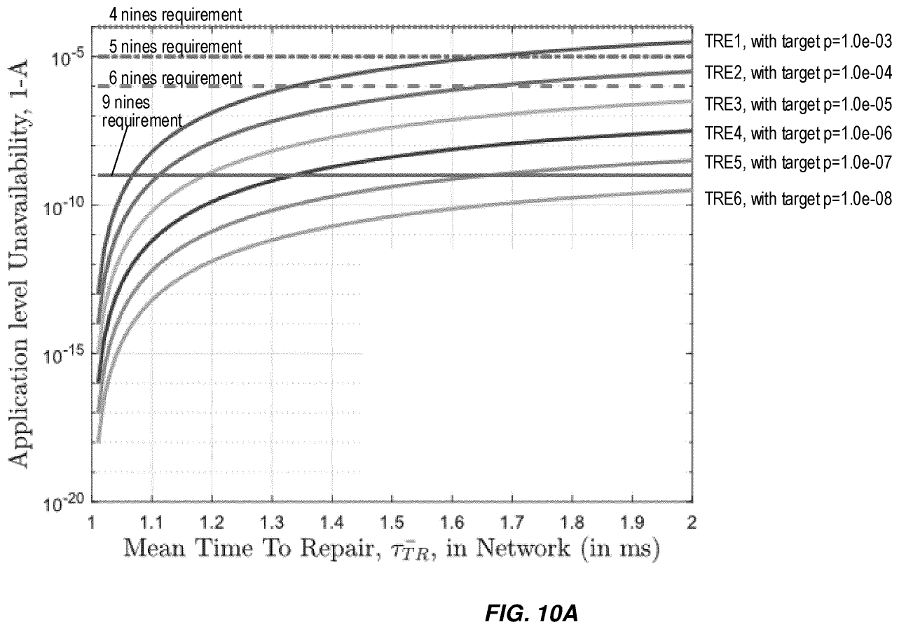

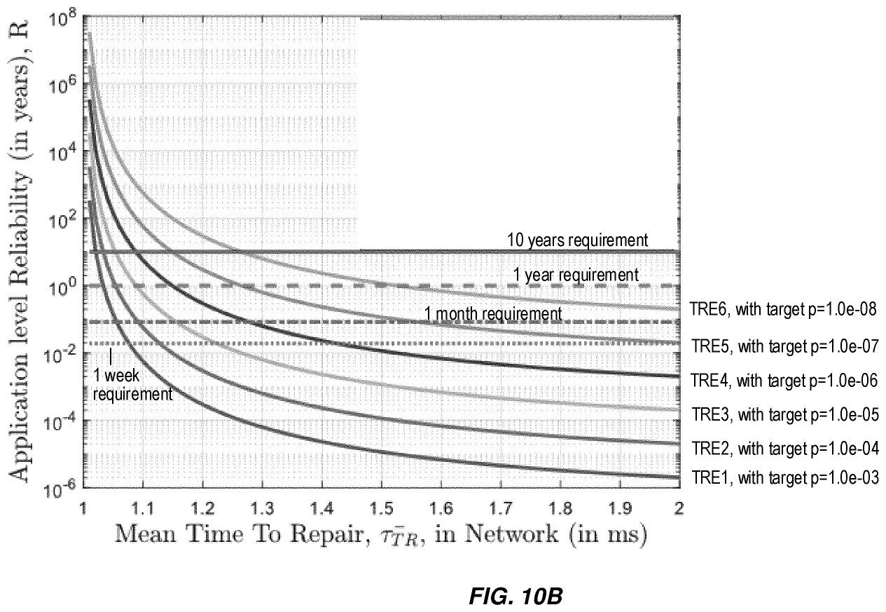

As another example, FIGS. 10A and 10B illustrate the impacts of mean time to repair (τ̅_{TR}) on application-level availability (A) and reliability (R) requirements for different values of packet failure probabilities (p) and assuming Nₛᵥ=5. These figures show six different values of p, ranging from 10⁻³ to 10⁻⁸, associated with six respective TREs, labelled TRE1-6. In addition, FIG. 10A shows four different application availability requirements ranging from four nines (i.e., 99.99%) to nine nines (i.e., 99.9999999%), while FIG. 10B shows four different application reliability requirements ranging one week to 10 years. From FIG. 10A, it can be seen that packet failure probability <10⁻⁴ is required for τ̅_{TR}=1.1 ms in order to fulfill the toughest requirement on availability (i.e., nine nines). On the other hand, FIG. 10B shows that in order to fulfill the 10-year reliability requirement, a packet failure probability <10⁻⁶ is required from the network layer for τ̅_{TR}=1.1 ms.

In some embodiments, a network node can determine one or more TREs needed to achieve one or more performance requirements of an application used by one or more UEs (e.g., as illustrated in FIG. 4). This can be based on mapping the application-level requirements to network level performance requirements, as discussed above. The network node can select TREs that enable and/or facilitate meeting the application-level requirements while minimizing, optimizing, and/or reducing resource expenditures by the network and/or the affected UEs.

In addition, the network node can configure the one or more UEs with such TREs. In some embodiments, the network node can configure the UEs ahead of time, e.g., when initializing the UEs to perform the application. In other embodiments, the network node can configure the UEs while the application is active based on changing conditions (e.g., traffic and/or channel) that no longer permit the network node to fulfill the application-level requirements. This can involve the network node monitoring actual values of network performance parameters and mapping those to actual application-level performance in the manner discussed above.

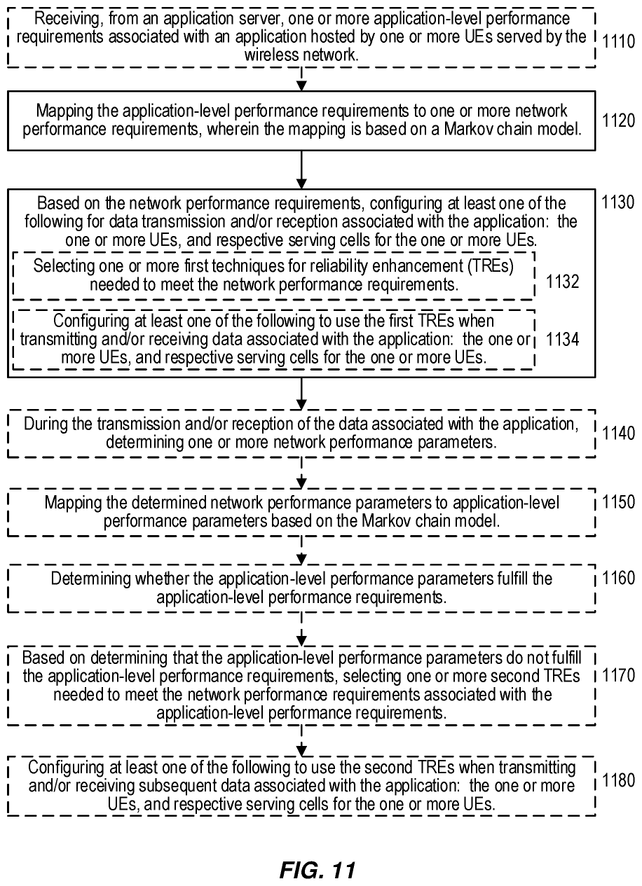

These embodiments described above can be further illustrated with reference to FIGS. 11-13, which depict exemplary methods (e.g., procedures) for a network node. Put differently, various features of the operations described below correspond to various embodiments described above. Although FIGS. 11-13 shows specific blocks in particular orders, the operations of the exemplary methods can be performed in different orders than shown and can be combined and/or divided into blocks having different functionality than shown. In addition, the exemplary procedures shown in FIGS. 11-13 can be used cooperatively in various combinations to provide various features, benefits, and/or solutions to problems. Optional blocks or operations are indicated by dashed lines.

In particular, FIG. 11 shows a flow diagram of an exemplary method (e.g., procedure) for managing network resources based on one or more application-level performance requirements associated with an application hosted by one or more UEs served by a wireless network, according to various exemplary embodiments of the present disclosure. The exemplary method can be performed by a network node (e.g., base station, eNB, gNB, gNB-CU, AMF, UPF, etc., or components thereof) in the wireless network (e.g., a 5G network). For example, the exemplary method shown in FIG. 11 can be performed by a network node configured according to other figures described herein.

The exemplary method can include the operations of block 1110, where the network node can receive the application-level performance requirements from an application server (e.g., an application function associated with the application). In some embodiments, the application can be a cyber-physical control application.

The exemplary method can also include the operations of block 1120, where the network node can map the application-level performance requirements to one or more network performance requirements. The mapping can be performed based on a Markov chain model, such as described above. For example, in some embodiments, the Markov chain model can comprise a state space partitioned into Nₛᵥ+2 states, [symbol] ={ [symbol] _{N}, 1, 2, . . . , [symbol] ₛᵥ, [symbol] }, where Nₛᵥ is a survival time of the application, state [symbol] _{N} represents a time that the wireless network is available, and state [symbol] represents a time that application becomes unavailable after Nₛᵥ consecutive packet failure events.

The exemplary method can also include the operations of block 1130, where based on the network performance requirements, the network node can configure at least one of the following for data transmission and/or reception associated with the application: the one or more UEs, and respective serving cells for the one or more UEs. The respective serving cells can be provided by the network node itself or by a further network node in the wireless network. The one or more UEs can be served by a single cell or different cells.

In various embodiments, the application-level performance requirements (e.g., received in block 1110) can include any of the following:
availability according to a predetermined quality of service (QoS);
reliability, relating to a duration between application outages; and
survival time, relating to the maximum number of consecutive lost packets that will not cause an application outage.

In various embodiments, the network performance requirements can include at least two of the following:
a mean time to repair (MTTR), relating to an average number of consecutive packet losses;
a mean time between failure (MTBF), relating to an average number of consecutive successful packets; and
a packet error rate.

In some embodiments, the configuring operations in block 1130 can include the operations of sub-blocks 1132-1134. In sub-block 1132, the network node can select one or more first techniques for reliability enhancement (TREs) needed to meet the network performance requirements. In sub-block 1134, the network node can configure at least one of the following to use the first TREs when transmitting and/or receiving data associated with the application: the one or more UEs, and respective serving cells for the one or more UEs. In various embodiments, the one or more first TREs can include any of the following:
carrier aggregation and/or dual connectivity;
data message repetition;
link adaptation based on modulation and coding scheme (MCS);
multi-antenna transmission and/or reception;
MAC-layer multiplexing and/or retransmission;
RLC-layer retransmission; and
PDCP-layer duplication.

In some embodiments, the exemplary method can also include the operations of blocks 1140-1180. In block 1140, during the transmission and/or reception of the data associated with the application, the network node determining one or more network performance parameters. Such network performance parameters can be related to and/or based on the network performance requirements discussed above. In block 1150, the network node can map the determined network performance parameters to application-level performance parameters based on the Markov chain model. In block 1160, the network node can determine whether the application-level performance parameters fulfill the application-level performance requirements (e.g., received in block 1110).

In block 1170, based on determining that the application-level performance parameters do not fulfill the application-level performance requirements (e.g., in block 1160), the network node can select one or more second TREs needed to meet the network performance requirements associated with the application-level performance requirements. The second TREs can include any of the first TREs, discussed above. Alternately, if the first TREs were provided during the configuring operation (e.g., in block 1130), at least some of the second TREs can be different than the first TREs. For example, if the first TREs included a particular data message repetition scheme and/or a particular MCS, a different data message repetition scheme and/or a different MCS can be selected as the second TREs.

In block 1180, the network node can configure at least one of the following to use the second TREs when transmitting and/or receiving subsequent data associated with the application: the one or more UEs, and the respective serving cells for the one or more UEs.

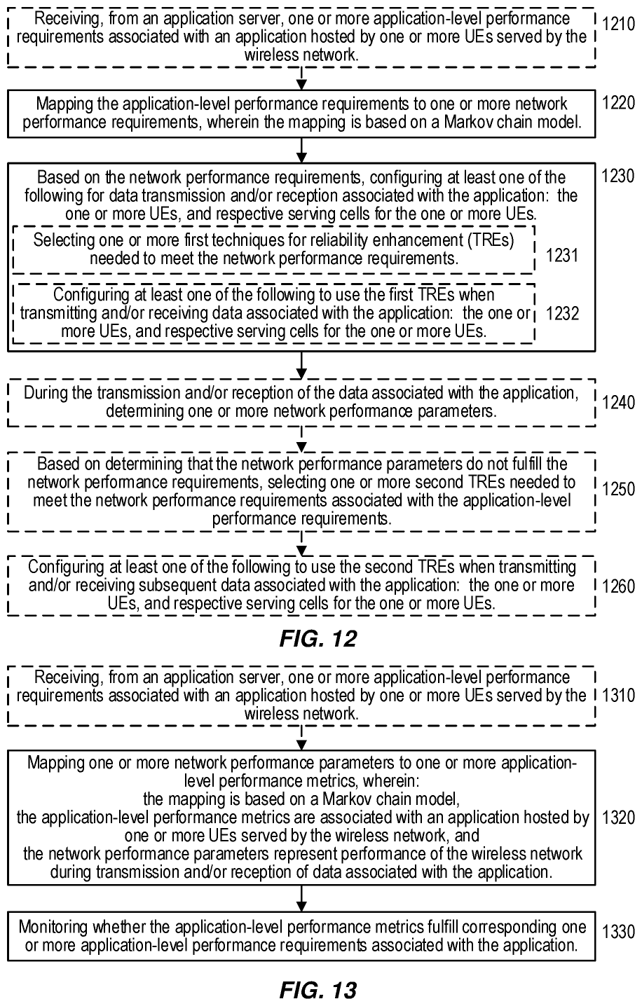

In addition, FIG. 12 shows a flow diagram of an exemplary method for managing network resources in a wireless network, according to various exemplary embodiments of the present disclosure. The exemplary method can be performed by a network node (e.g., base station, eNB, gNB, gNB-CU, AMF, UPF, etc., or components thereof) in the wireless network (e.g., a 5G network). For example, the exemplary method shown in FIG. 12 can be performed by a network node configured according to other figures described herein.

The exemplary method can include the operations of block 1220, where the network node can map one or more application-level performance requirements to one or more network performance requirements. The mapping can be performed based on a Markov chain model, such as described above. In addition, the application-level performance requirements can be associated with an application hosted by one or more UEs served by the wireless network.

The exemplary method can also include the operations of block 1230, where based on the network performance requirements, the network node can configure at least one of the following for data transmission and/or reception associated with the application: the one or more UEs, and respective serving cells for the one or more UEs. The respective serving cells can be provided by the network node itself or by a further network node in the wireless network. The one or more UEs can be served by a single cell or different cells.

In some embodiments, the exemplary method can include the operations of block 1210, where the network node can receive the application-level performance requirements from an application server (e.g., an application function, AF) associated with the application.

In various embodiments, the application-level performance requirements (e.g., received in block 1210) can include any of the following:
Availability (A) of the application according to a predetermined quality of service;
Reliability (R) relating to a mean time between application outages; and
Survival time (N_sv) relating to a maximum number of consecutive lost packets that will not cause an application outage.
   In some embodiments, the mapping (e.g., in block 1220) can be based on three parameters associated with the application-level performance requirements.

In various embodiments, the network performance requirements can include any of the following:
Mean time to repair (τ̅_{TR}) relating to an average number of consecutive packet losses;
Mean time between failure (τ̅_{BF}) relating to an average number of consecutive successfully-received packets; and
Packet error rate (PER).

In some embodiments, the Markov chain model can comprise a state space partitioned into Nₛᵥ+2 states, [symbol] ={ [symbol] _{N}, 1, 2, . . . , [symbol] ₛᵥ, [symbol] }, where Nₛᵥ is a survival time of the application, state [symbol] _{N} represents a time that the wireless network is available, and state [symbol] represents a time that application becomes unavailable after Nₛᵥ consecutive packet failure events. In some embodiments, the Markov chain model can also include a state transition matrix, M, having entries that are based on the following network performance requirements: a mean time to repair, τ̅_{TR}, relating to an average number of consecutive packet losses and a mean time between failure, τ̅_{BF}, relating to an average number of consecutive successfully transmitted packets.

In some embodiments, the application can be a cyber-physical control application, the wireless network can be a 5G network, and the network node can be one of the following: a base station (gNB) or component thereof; an access and mobility management function (AMF); or a user plane function (UPF).

In some embodiments, the configuring operations in block 1230 can include the operations of sub-blocks 1231-1232. In sub-block 1231, the network node can select one or more first techniques for reliability enhancement (TREs) needed to meet the network performance requirements. In sub-block 1232, the network node can configure at least one of the following to use the first TREs when transmitting and/or receiving data associated with the application: the one or more UEs, and respective serving cells for the one or more UEs. In various embodiments, the one or more first TREs can include any of the following:
increased transmission power;
carrier aggregation;
dual connectivity;
data message repetition;
link adaptation based on modulation and coding scheme (MCS);
multi-antenna transmission and/or reception;
MAC-layer multiplexing and/or retransmission;
RLC-layer retransmission; and
PDCP-layer duplication.

In some embodiments, the exemplary method can also include the operations of blocks 1240-1260. In block 1240, during the transmission and/or reception of the data associated with the application, the network node can determine one or more network performance parameters. Such network performance parameters can be related to and/or based on the network performance requirements discussed above. In block 1250, based on determining that the one or more network performance parameters do not fulfill the mapped one or more network performance requirements, the network node can select one or more second TREs needed to meet the network performance requirements. The second TREs can include any of the first TREs, discussed above. Alternately, if the first TREs were provided during the configuring operation (e.g., in block 1230), at least some of the second TREs can be different than the first TREs. For example, if the first TREs included a particular data message repetition scheme and/or a particular MCS, a different data message repetition scheme and/or a different MCS can be selected as the second TREs.

In block 1260, the network node can configure at least one of the following to use the second TREs when transmitting and/or receiving subsequent data associated with the application: the one or more UEs, and the respective serving cells for the one or more UEs.

In addition, FIG. 13 shows a flow diagram of another exemplary method for managing network resources in a wireless network, according to various exemplary embodiments of the present disclosure. The exemplary method can be performed by a network node (e.g., base station, eNB, gNB, gNB-CU, AMF, UPF, etc., or components thereof) in the wireless network (e.g., a 5G network). For example, the exemplary method shown in FIG. 13 can be performed by a network node configured according to other figures described herein.

The exemplary method can include the operations of block 1320, where the network node can map one or more network performance parameters to one or more application-level performance metrics. The mapping can be performed based on a Markov chain model, such as described above. In addition, the application-level performance metrics can be associated with an application hosted by one or more UEs served by the wireless network, while the network performance parameters can represent performance of the wireless network during transmission and/or reception of data associated with the application. The exemplary method can also include the operations of block 1330, where the network node can monitor whether the application-level performance metrics fulfill corresponding one or more application-level performance requirements associated with the application. In some embodiments, the network node can perform the monitoring in relation to a service level agreement (SLA).

In some embodiments, the exemplary method can also include the operations of block 1310, where the network node can receive the application-level performance requirements from an application server (e.g., an application function, AF) associated with the application.

In various embodiments, the application-level performance metrics (e.g., mapped in block 1320) can include any of the following:
Availability (A) of the application according to a predetermined quality of service;
Reliability (R) relating to a mean time between application outages; and
Survival time (N_sv) relating to a maximum number of consecutive lost packets.

In various embodiments, the network performance parameters can include any of the following:
Mean time to repair (τ̅_{TR}) relating to an average number of consecutive packet losses;
Mean time between failure (τ̅_{BF}) relating to an average number of consecutive successfully-received packets; and
Packet error rate (PER).
   In some of these embodiments, the mapping (e.g., in block 1320) can be based on two network performance parameters.

In some embodiments, the Markov chain model can comprise a state space partitioned into Nₛᵥ+2 states, [symbol] ={ [symbol] _{N}, 1, 2, . . . , [symbol] ₛᵥ, [symbol] }, where Nₛᵥ is a survival time of the application, state [symbol] _{N} represents a time that the wireless network is available, and state [symbol] represents a time that application becomes unavailable after Nₛᵥ consecutive packet failure events. In some embodiments, the Markov chain model can also include a state transition matrix, M, having entries that are based on the following network performance requirements: a mean time to repair, τ̅_{TR}, relating to an average number of consecutive packet losses and a mean time between failure, τ̅_{BF}, relating to an average number of consecutive successfully transmitted packets.

In some embodiments, the application can be a cyber-physical control application, the wireless network can be a 5G network, and the network node can be one of the following: a base station (gNB) or component thereof; an access and mobility management function (AMF); or a user plane function (UPF).

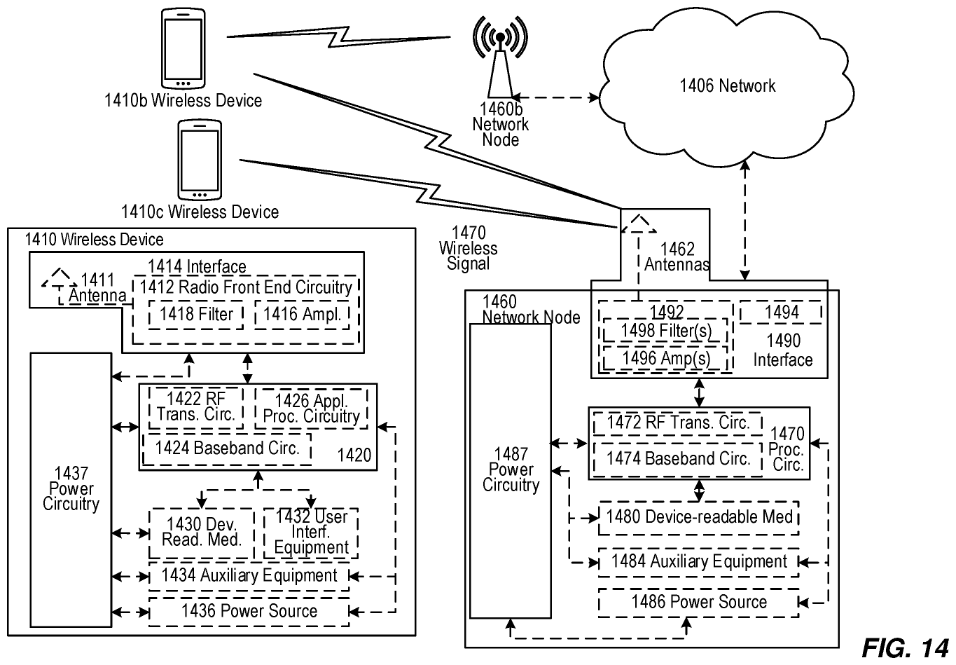

Although the subject matter described herein may be implemented in any appropriate type of system using any suitable components, the embodiments disclosed herein are described in relation to a wireless network, such as the example wireless network illustrated in FIG. 14. For simplicity, the wireless network of FIG. 14 only depicts network 1406, network nodes 1460 and 1460b, and WDs 1410, 1410b, and 1410c. In practice, a wireless network may further include any additional elements suitable to support communication between wireless devices or between a wireless device and another communication device, such as a landline telephone, a service provider, or any other network node or end device. Of the illustrated components, network node 1460 and wireless device (WD) 1410 are depicted with additional detail. The wireless network may provide communication and other types of services to one or more wireless devices to facilitate the wireless devices' access to and/or use of the services provided by, or via, the wireless network.

The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), Narrowband Internet of Things (NB-IoT), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network 1406 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 1460 and WD 1410 comprise various components described in more detail below. These components work together in order to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

Examples of network nodes include, but are not limited to, access points (APs) (e.g., radio access points) and base stations (BSs) (e.g., radio base stations, NBs, eNBs, and gNBs). Base stations can be categorized based on the amount of coverage they provide (or, stated differently, their transmit power level) and can then also be referred to as femto base stations, pico base stations, micro base stations, or macro base stations. A base station can be a relay node or a relay donor node controlling a relay. A network node can also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station can also be referred to as nodes in a distributed antenna system (DAS).

Further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs. As another example, a network node can be a virtual network node as described in more detail below.

In FIG. 14, network node 1460 includes processing circuitry 1470, device readable medium 1480, interface 1490, auxiliary equipment 1484, power source 1486, power circuitry 1487, and antenna 1462. Although network node 1460 illustrated in the example wireless network of FIG. 14 may represent a device that includes the illustrated combination of hardware components, other embodiments may comprise network nodes with different combinations of components. It is to be understood that a network node comprises any suitable combination of hardware and/or software needed to perform the tasks, features, functions and methods disclosed herein. Moreover, while the components of network node 1460 are depicted as single boxes located within a larger box, or nested within multiple boxes, in practice, a network node may comprise multiple different physical components that make up a single illustrated component (e.g., device readable medium 1480 may comprise multiple separate hard drives as well as multiple RAM modules).

Similarly, network node 1460 may be composed of multiple physically separate components (e.g., a NodeB component and an RNC component, or a BTS component and a BSC component, etc.), which may each have their own respective components. In certain scenarios in which network node 1460 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node. In some embodiments, network node 1460 may be configured to support multiple radio access technologies (RATs). In such embodiments, some components may be duplicated (e.g., separate device readable medium 1480 for the different RATs) and some components may be reused (e.g., the same antenna 1462 may be shared by the RATs). Network node 1460 may also include multiple sets of the various illustrated components for different wireless technologies integrated into network node 1460, such as, for example, GSM, WCDMA, LTE, NR, WiFi, or Bluetooth wireless technologies. These wireless technologies may be integrated into the same or different chip or set of chips and other components within network node 1460.

Processing circuitry 1470 is configured to perform any determining, calculating, or similar operations (e.g., certain obtaining operations) described herein as being provided by a network node. These operations performed by processing circuitry 1470 may include processing information obtained by processing circuitry 1470 by, for example, converting the obtained information into other information, comparing the obtained information or converted information to information stored in the network node, and/or performing one or more operations based on the obtained information or converted information, and as a result of said processing making a determination.

Processing circuitry 1470 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1460 components, such as device readable medium 1480, network node 1460 functionality. For example, processing circuitry 1470 may execute instructions stored in device readable medium 1480 or in memory within processing circuitry 1470. Such functionality may include providing any of the various wireless features, functions, or benefits discussed herein. In some embodiments, processing circuitry 1470 may include a system on a chip (SOC).

In some embodiments, processing circuitry 1470 may include one or more of radio frequency (RF) transceiver circuitry 1472 and baseband processing circuitry 1474. In some embodiments, radio frequency (RF) transceiver circuitry 1472 and baseband processing circuitry 1474 may be on separate chips (or sets of chips), boards, or units, such as radio units and digital units. In alternative embodiments, part or all of RF transceiver circuitry 1472 and baseband processing circuitry 1474 may be on the same chip or set of chips, boards, or units

In certain embodiments, some or all of the functionality described herein as being provided by a network node, base station, eNB or other such network device may be performed by processing circuitry 1470 executing instructions stored on device readable medium 1480 or memory within processing circuitry 1470. In alternative embodiments, some or all of the functionality may be provided by processing circuitry 1470 without executing instructions stored on a separate or discrete device readable medium, such as in a hard-wired manner. In any of those embodiments, whether executing instructions stored on a device readable storage medium or not, processing circuitry 1470 can be configured to perform the described functionality. The benefits provided by such functionality are not limited to processing circuitry 1470 alone or to other components of network node 1460, but are enjoyed by network node 1460 as a whole, and/or by end users and the wireless network generally.

Device readable medium 1480 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 1470. Device readable medium 1480 may store any suitable instructions, data or information, including a computer program, software, an application including one or more of logic, rules, code, tables, etc. and/or other instructions capable of being executed by processing circuitry 1470 and, utilized by network node 1460. Device readable medium 1480 may be used to store any calculations made by processing circuitry 1470 and/or any data received via interface 1490. In some embodiments, processing circuitry 1470 and device readable medium 1480 may be considered to be integrated.

Interface 1490 is used in the wired or wireless communication of signaling and/or data between network node 1460, network 1406, and/or WDs 1410. As illustrated, interface 1490 comprises port(s)/terminal(s) 1494 to send and receive data, for example to and from network 1406 over a wired connection. Interface 1490 also includes radio front end circuitry 1492 that may be coupled to, or in certain embodiments a part of, antenna 1462. Radio front end circuitry 1492 comprises filters 1498 and amplifiers 1496. Radio front end circuitry 1492 may be connected to antenna 1462 and processing circuitry 1470. Radio front end circuitry may be configured to condition signals communicated between antenna 1462 and processing circuitry 1470. Radio front end circuitry 1492 may receive digital data that is to be sent out to other network nodes or WDs via a wireless connection. Radio front end circuitry 1492 may convert the digital data into a radio signal having the appropriate channel and bandwidth parameters using a combination of filters 1498 and/or amplifiers 1496. The radio signal may then be transmitted via antenna 1462. Similarly, when receiving data, antenna 1462 may collect radio signals which are then converted into digital data by radio front end circuitry 1492. The digital data may be passed to processing circuitry 1470. In other embodiments, the interface may comprise different components and/or different combinations of components.

In certain alternative embodiments, network node 1460 may not include separate radio front end circuitry 1492, instead, processing circuitry 1470 may comprise radio front end circuitry and may be connected to antenna 1462 without separate radio front end circuitry 1492. Similarly, in some embodiments, all or some of RF transceiver circuitry 1472 may be considered a part of interface 1490. In still other embodiments, interface 1490 may include one or more ports or terminals 1494, radio front end circuitry 1492, and RF transceiver circuitry 1472, as part of a radio unit (not shown), and interface 1490 may communicate with baseband processing circuitry 1474, which is part of a digital unit (not shown).

Antenna 1462 may include one or more antennas, or antenna arrays, configured to send and/or receive wireless signals. Antenna 1462 may be coupled to radio front end circuitry 1490 and may be any type of antenna capable of transmitting and receiving data and/or signals wirelessly. In some embodiments, antenna 1462 may comprise one or more omni-directional, sector or panel antennas operable to transmit/receive radio signals between, for example, 2 GHz and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna 1462 may be separate from network node 1460 and may be connectable to network node 1460 through an interface or port.

Antenna 1462, interface 1490, and/or processing circuitry 1470 may be configured to perform any receiving operations and/or certain obtaining operations described herein as being performed by a network node. Any information, data and/or signals may be received from a wireless device, another network node and/or any other network equipment. Similarly, antenna 1462, interface 1490, and/or processing circuitry 1470 may be configured to perform any transmitting operations described herein as being performed by a network node. Any information, data and/or signals may be transmitted to a wireless device, another network node and/or any other network equipment.

Power circuitry 1487 may comprise, or be coupled to, power management circuitry and is configured to supply the components of network node 1460 with power for performing the functionality described herein. Power circuitry 1487 may receive power from power source 1486. Power source 1486 and/or power circuitry 1487 may be configured to provide power to the various components of network node 1460 in a form suitable for the respective components (e.g., at a voltage and current level needed for each respective component). Power source 1486 may either be included in, or external to, power circuitry 1487 and/or network node 1460. For example, network node 1460 may be connectable to an external power source (e.g., an electricity outlet) via an input circuitry or interface such as an electrical cable, whereby the external power source supplies power to power circuitry 1487. As a further example, power source 1486 may comprise a source of power in the form of a battery or battery pack which is connected to, or integrated in, power circuitry 1487. The battery may provide backup power should the external power source fail. Other types of power sources, such as photovoltaic devices, may also be used.

Alternative embodiments of network node 1460 may include additional components beyond those shown in FIG. 14 that may be responsible for providing certain aspects of the network node's functionality, including any of the functionality described herein and/or any functionality necessary to support the subject matter described herein. For example, network node 1460 may include user interface equipment to allow input of information into network node 1460 and to allow output of information from network node 1460. This may allow a user to perform diagnostic, maintenance, repair, and other administrative functions for network node 1460.

In some embodiments, a wireless device (WD, e.g., WD 1410) can be configured to transmit and/or receive information without direct human interaction. For instance, a WD can be designed to transmit information to a network on a predetermined schedule, when triggered by an internal or external event, or in response to requests from the network. Examples of a WD include, but are not limited to, smart phones, mobile phones, cell phones, voice over IP (VoIP) phones, wireless local loop phones, desktop computers, personal digital assistants (PDAs), wireless cameras, gaming consoles or devices, music storage devices, playback appliances, wearable devices, wireless endpoints, mobile stations, tablets, laptops, laptop-embedded equipment (LEE), laptop-mounted equipment (LME), smart devices, wireless customer-premise equipment (CPE), mobile-type communication (MTC) devices, Internet-of-Things (IoT) devices, vehicle-mounted wireless terminal devices, etc.

A WD can support device-to-device (D2D) communication, for example by implementing a 3GPP standard for sidelink communication, vehicle-to-vehicle (V2V), vehicle-to-infrastructure (V2I), vehicle-to-everything (V2X) and can in this case be referred to as a D2D communication device. As yet another specific example, in an Internet of Things (IoT) scenario, a WD can represent a machine or other device that performs monitoring and/or measurements and transmits the results of such monitoring and/or measurements to another WD and/or a network node. The WD can in this case be a machine-to-machine (M2M) device, which can in a 3GPP context be referred to as an MTC device. As one particular example, the WD can be a UE implementing the 3GPP narrow band internet of things (NB-IoT) standard. Other examples of such machines or devices are sensors, metering devices such as power meters, industrial machinery, or home or personal appliances (e.g., refrigerators, televisions, etc.) personal wearables (e.g., watches, fitness trackers, etc.). In other scenarios, a WD can represent a vehicle or other equipment that is capable of monitoring and/or reporting on its operational status or other functions associated with its operation. A WD as described above can represent the endpoint of a wireless connection, in which case the device can be referred to as a wireless terminal. Furthermore, a WD as described above can be mobile, in which case it can also be referred to as a mobile device or a mobile terminal.

As illustrated, wireless device 1410 includes antenna 1411, interface 1414, processing circuitry 1420, device readable medium 1430, user interface equipment 1432, auxiliary equipment 1434, power source 1436 and power circuitry 1437. WD 1410 may include multiple sets of one or more of the illustrated components for different wireless technologies supported by WD 1410, such as, for example, GSM, WCDMA, LTE, NR, WiFi, WiMAX, NB-IoT, or Bluetooth wireless technologies, just to mention a few. These wireless technologies may be integrated into the same or different chips or set of chips as other components within WD 1410.

Antenna 1411 may include one or more antennas or antenna arrays, configured to send and/or receive wireless signals, and is connected to interface 1414. In certain alternative embodiments, antenna 1411 may be separate from WD 1410 and be connectable to WD 1410 through an interface or port. Antenna 1411, interface 1414, and/or processing circuitry 1420 may be configured to perform any receiving or transmitting operations described herein as being performed by a WD. Any information, data and/or signals may be received from a network node and/or another WD. In some embodiments, radio front end circuitry and/or antenna 1411 may be considered an interface.

As illustrated, interface 1414 comprises radio front end circuitry 1412 and antenna 1411. Radio front end circuitry 1412 comprise one or more filters 1418 and amplifiers 1416. Radio front end circuitry 1414 is connected to antenna 1411 and processing circuitry 1420, and is configured to condition signals communicated between antenna 1411 and processing circuitry 1420. Radio front end circuitry 1412 may be coupled to or a part of antenna 1411. In some embodiments, WD 1410 may not include separate radio front end circuitry 1412; rather, processing circuitry 1420 may comprise radio front end circuitry and may be connected to antenna 1411. Similarly, in some embodiments, some or all of RF transceiver circuitry 1422 may be considered a part of interface 1414. Radio front end circuitry 1412 may receive digital data that is to be sent out to other network nodes or WDs via a wireless connection. Radio front end circuitry 1412 may convert the digital data into a radio signal having the appropriate channel and bandwidth parameters using a combination of filters 1418 and/or amplifiers 1416. The radio signal may then be transmitted via antenna 1411. Similarly, when receiving data, antenna 1411 may collect radio signals which are then converted into digital data by radio front end circuitry 1412. The digital data may be passed to processing circuitry 1420. In other embodiments, the interface may comprise different components and/or different combinations of components.

Processing circuitry 1420 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other WD 1410 components, such as device readable medium 1430, WD 1410 functionality. Such functionality may include providing any of the various wireless features or benefits discussed herein. For example, processing circuitry 1420 may execute instructions stored in device readable medium 1430 or in memory within processing circuitry 1420 to provide the functionality disclosed herein.

As illustrated, processing circuitry 1420 includes one or more of RF transceiver circuitry 1422, baseband processing circuitry 1424, and application processing circuitry 1426. In other embodiments, the processing circuitry may comprise different components and/or different combinations of components. In certain embodiments processing circuitry 1420 of WD 1410 may comprise a SOC. In some embodiments, RF transceiver circuitry 1422, baseband processing circuitry 1424, and application processing circuitry 1426 may be on separate chips or sets of chips. In alternative embodiments, part or all of baseband processing circuitry 1424 and application processing circuitry 1426 may be combined into one chip or set of chips, and RF transceiver circuitry 1422 may be on a separate chip or set of chips. In still alternative embodiments, part or all of RF transceiver circuitry 1422 and baseband processing circuitry 1424 may be on the same chip or set of chips, and application processing circuitry 1426 may be on a separate chip or set of chips. In yet other alternative embodiments, part or all of RF transceiver circuitry 1422, baseband processing circuitry 1424, and application processing circuitry 1426 may be combined in the same chip or set of chips. In some embodiments, RF transceiver circuitry 1422 may be a part of interface 1414. RF transceiver circuitry 1422 may condition RF signals for processing circuitry 1420.

In certain embodiments, some or all of the functionality described herein as being performed by a WD may be provided by processing circuitry 1420 executing instructions stored on device readable medium 1430, which in certain embodiments may be a computer-readable storage medium. In alternative embodiments, some or all of the functionality may be provided by processing circuitry 1420 without executing instructions stored on a separate or discrete device readable storage medium, such as in a hard-wired manner. In any of those particular embodiments, whether executing instructions stored on a device readable storage medium or not, processing circuitry 1420 can be configured to perform the described functionality. The benefits provided by such functionality are not limited to processing circuitry 1420 alone or to other components of WD 1410, but are enjoyed by WD 1410 as a whole, and/or by end users and the wireless network generally.

Processing circuitry 1420 may be configured to perform any determining, calculating, or similar operations (e.g., certain obtaining operations) described herein as being performed by a WD. These operations, as performed by processing circuitry 1420, may include processing information obtained by processing circuitry 1420 by, for example, converting the obtained information into other information, comparing the obtained information or converted information to information stored by WD 1410, and/or performing one or more operations based on the obtained information or converted information, and as a result of said processing making a determination.

Device readable medium 1430 may be operable to store a computer program, software, an application including one or more of logic, rules, code, tables, etc. and/or other instructions capable of being executed by processing circuitry 1420. Device readable medium 1430 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry 1420. In some embodiments, processing circuitry 1420 and device readable medium 1430 may be considered to be integrated.

User interface equipment 1432 may provide components that allow for a human user to interact with WD 1410. Such interaction may be of many forms, such as visual, audial, tactile, etc. User interface equipment 1432 may be operable to produce output to the user and to allow the user to provide input to WD 1410. The type of interaction may vary depending on the type of user interface equipment 1432 installed in WD 1410. For example, if WD 1410 is a smart phone, the interaction may be via a touch screen; if WD 1410 is a smart meter, the interaction may be through a screen that provides usage (e.g., the number of gallons used) or a speaker that provides an audible alert (e.g., if smoke is detected). User interface equipment 1432 may include input interfaces, devices and circuits, and output interfaces, devices and circuits. User interface equipment 1432 is configured to allow input of information into WD 1410 and is connected to processing circuitry 1420 to allow processing circuitry 1420 to process the input information. User interface equipment 1432 may include, for example, a microphone, a proximity or other sensor, keys/buttons, a touch display, one or more cameras, a USB port, or other input circuitry. User interface equipment 1432 is also configured to allow output of information from WD 1410, and to allow processing circuitry 1420 to output information from WD 1410. User interface equipment 1432 may include, for example, a speaker, a display, vibrating circuitry, a USB port, a headphone interface, or other output circuitry. Using one or more input and output interfaces, devices, and circuits, of user interface equipment 1432, WD 1410 may communicate with end users and/or the wireless network, thereby allowing them to benefit from the functionality described herein.

Auxiliary equipment 1434 is operable to provide more specific functionality which may not be generally performed by WDs. This may comprise specialized sensors for doing measurements for various purposes, interfaces for additional types of communication such as wired communications etc. The inclusion and type of components of auxiliary equipment 1434 may vary depending on the embodiment and/or scenario.

Power source 1436 may, in some embodiments, be in the form of a battery or battery pack. Other types of power sources, such as an external power source (e.g., an electricity outlet), photovoltaic devices or power cells, may also be used. WD 1410 may further comprise power circuitry 1437 for delivering power from power source 1436 to the various parts of WD 1410 which need power from power source 1436 to carry out any functionality described or indicated herein. Power circuitry 1437 may in certain embodiments comprise power management circuitry. Power circuitry 1437 may additionally or alternatively be operable to receive power from an external power source; in which case WD 1410 may be connectable to the external power source (such as an electricity outlet) via input circuitry or an interface such as an electrical power cable. Power circuitry 1437 may also in certain embodiments be operable to deliver power from an external power source to power source 1436. This may be, for example, for the charging of power source 1436. Power circuitry 1437 may perform any formatting, converting, or other modification to the power from power source 1436 to make the power suitable for the respective components of WD 1410 to which power is supplied.

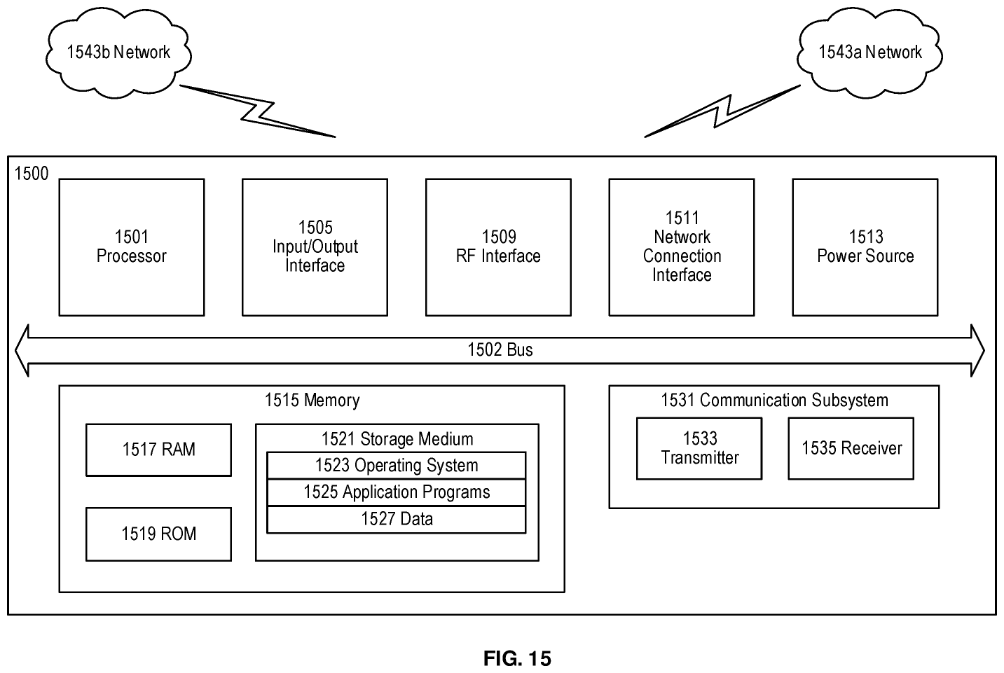

FIG. 15 illustrates one embodiment of a UE in accordance with various aspects described herein. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter). UE 15200 may be any UE identified by the 3^{rd} Generation Partnership Project (3GPP), including a NB-IoT UE, a machine type communication (MTC) UE, and/or an enhanced MTC (eMTC) UE. UE 1500, as illustrated in FIG. 15, is one example of a WD configured for communication in accordance with one or more communication standards promulgated by the 3^{rd} Generation Partnership Project (3GPP), such as 3GPP's GSM, UMTS, LTE, and/or 5G standards. As mentioned previously, the term WD and UE may be used interchangeable. Accordingly, although FIG. 15 is a UE, the components discussed herein are equally applicable to a WD, and vice-versa.

In FIG. 15, UE 1500 includes processing circuitry 1501 that is operatively coupled to input/output interface 1505, radio frequency (RF) interface 1509, network connection interface 1511, memory 1515 including random access memory (RAM) 1517, read-only memory (ROM) 1519, and storage medium 1521 or the like, communication subsystem 1531, power source 1533, and/or any other component, or any combination thereof. Storage medium 1521 includes operating system 1523, application program 1525, and data 1527. In other embodiments, storage medium 1521 may include other similar types of information. Certain UEs may utilize all of the components shown in FIG. 15, or only a subset of the components. The level of integration between the components may vary from one UE to another UE. Further, certain UEs may contain multiple instances of a component, such as multiple processors, memories, transceivers, transmitters, receivers, etc.

In FIG. 15, processing circuitry 1501 may be configured to process computer instructions and data. Processing circuitry 1501 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry 1501 may include two central processing units (CPUs). Data may be information in a form suitable for use by a computer.

In the depicted embodiment, input/output interface 1505 may be configured to provide a communication interface to an input device, output device, or input and output device. UE 1500 may be configured to use an output device via input/output interface 1505. An output device may use the same type of interface port as an input device. For example, a USB port may be used to provide input to and output from UE 1500. The output device may be a speaker, a sound card, a video card, a display, a monitor, a printer, an actuator, an emitter, a smartcard, another output device, or any combination thereof. UE 1500 may be configured to use an input device via input/output interface 1505 to allow a user to capture information into UE 1500. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor.

In FIG. 15, RF interface 1509 may be configured to provide a communication interface to RF components such as a transmitter, a receiver, and an antenna. Network connection interface 1511 may be configured to provide a communication interface to network 1543a. Network 1543a may encompass wired and/or wireless networks such as a local-area network (LAN), a wide-area network (WAN), a computer network, a wireless network, a telecommunications network, another like network or any combination thereof. For example, network 1543a may comprise a Wi-Fi network. Network connection interface 1511 may be configured to include a receiver and a transmitter interface used to communicate with one or more other devices over a communication network according to one or more communication protocols, such as Ethernet, TCP/IP, SONET, ATM, or the like. Network connection interface 1511 may implement receiver and transmitter functionality appropriate to the communication network links (e.g., optical, electrical, and the like). The transmitter and receiver functions may share circuit components, software or firmware, or alternatively may be implemented separately.

RAM 1517 may be configured to interface via bus 1502 to processing circuitry 1501 to provide storage or caching of data or computer instructions during the execution of software programs such as the operating system, application programs, and device drivers. ROM 1519 may be configured to provide computer instructions or data to processing circuitry 1501. For example, ROM 1519 may be configured to store invariant low-level system code or data for basic system functions such as basic input and output (I/O), startup, or reception of keystrokes from a keyboard that are stored in a non-volatile memory. Storage medium 1521 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium 1521 may be configured to include operating system 1523, application program 1525 such as a web browser application, a widget or gadget engine or another application, and data file 1527. Storage medium 1521 may store, for use by UE 1500, any of a variety of various operating systems or combinations of operating systems.

Storage medium 1521 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium 1521 may allow UE 1500 to access computer-executable instructions, application programs or the like, stored on transitory or non-transitory memory media, to off-load data, or to upload data. An article of manufacture, such as one utilizing a communication system may be tangibly embodied in storage medium 1521, which may comprise a device readable medium.

In FIG. 15, processing circuitry 1501 may be configured to communicate with network 1543b using communication subsystem 1531. Network 1543a and network 1543b may be the same network or networks or different network or networks. Communication subsystem 1531 may be configured to include one or more transceivers used to communicate with network 1543b. For example, communication subsystem 1531 may be configured to include one or more transceivers used to communicate with one or more remote transceivers of another device capable of wireless communication such as another WD, UE, or base station of a radio access network (RAN) according to one or more communication protocols, such as IEEE 802.15, CDMA, WCDMA, GSM, LTE, UTRAN, WiMax, or the like. Each transceiver may include transmitter 1533 and/or receiver 1535 to implement transmitter or receiver functionality, respectively, appropriate to the RAN links (e.g., frequency allocations and the like). Further, transmitter 1533 and receiver 1535 of each transceiver may share circuit components, software or firmware, or alternatively may be implemented separately.

In the illustrated embodiment, the communication functions of communication subsystem 1531 may include data communication, voice communication, multimedia communication, short-range communications such as Bluetooth, near-field communication, location-based communication such as the use of the global positioning system (GPS) to determine a location, another like communication function, or any combination thereof. For example, communication subsystem 1531 may include cellular communication, Wi-Fi communication, Bluetooth communication, and GPS communication. Network 1543b may encompass wired and/or wireless networks such as a local-area network (LAN), a wide-area network (WAN), a computer network, a wireless network, a telecommunications network, another like network or any combination thereof. For example, network 1543b may be a cellular network, a Wi-Fi network, and/or a near-field network. Power source 1513 may be configured to provide alternating current (AC) or direct current (DC) power to components of UE 1500.

The features, benefits and/or functions described herein may be implemented in one of the components of UE 1500 or partitioned across multiple components of UE 1500. Further, the features, benefits, and/or functions described herein may be implemented in any combination of hardware, software or firmware. In one example, communication subsystem 1531 may be configured to include any of the components described herein. Further, processing circuitry 1501 may be configured to communicate with any of such components over bus 1502. In another example, any of such components may be represented by program instructions stored in memory that when executed by processing circuitry 1501 perform the corresponding functions described herein. In another example, the functionality of any of such components may be partitioned between processing circuitry 1501 and communication subsystem 1531. In another example, the non-computationally intensive functions of any of such components may be implemented in software or firmware and the computationally intensive functions may be implemented in hardware.

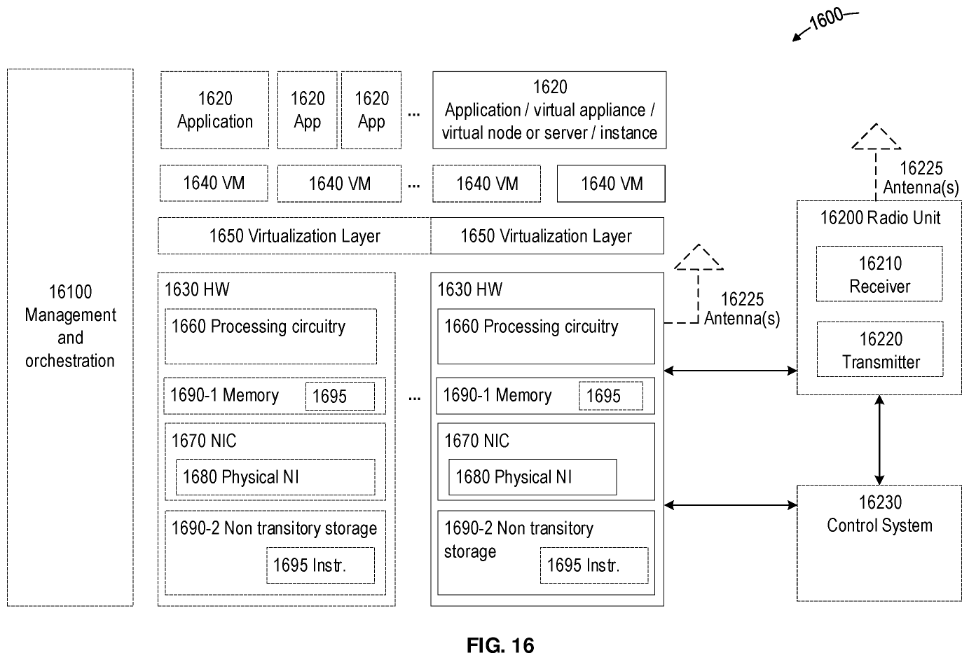

FIG. 16 is a schematic block diagram illustrating a virtualization environment 1600 in which functions implemented by some embodiments may be virtualized. In the present context, virtualizing means creating virtual versions of apparatuses or devices which may include virtualizing hardware platforms, storage devices and networking resources. As used herein, virtualization can be applied to a node (e.g., a virtualized base station or a virtualized radio access node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments 1600 hosted by one or more of hardware nodes 1630. Further, in embodiments in which the virtual node is not a radio access node or does not require radio connectivity (e.g., a core network node), then the network node may be entirely virtualized.

The functions may be implemented by one or more applications 1620 (which may alternatively be called software instances, virtual appliances, network functions, virtual nodes, virtual network functions, etc.) operative to implement some of the features, functions, and/or benefits of some of the embodiments disclosed herein. Applications 1620 are run in virtualization environment 1600 which provides hardware 1630 comprising processing circuitry 1660 and memory 1690. Memory 1690 contains instructions 1695 executable by processing circuitry 1660 whereby application 1620 is operative to provide one or more of the features, benefits, and/or functions disclosed herein.

Virtualization environment 1600, comprises general-purpose or special-purpose network hardware devices 1630 comprising a set of one or more processors or processing circuitry 1660, which may be commercial off-the-shelf (COTS) processors, dedicated Application Specific Integrated Circuits (ASICs), or any other type of processing circuitry including digital or analog hardware components or special purpose processors. Each hardware device may comprise memory 1690-1 which may be non-persistent memory for temporarily storing instructions 1695 or software executed by processing circuitry 1660. Each hardware device may comprise one or more network interface controllers (NICs) 1670, also known as network interface cards, which include physical network interface 1680. Each hardware device may also include non-transitory, persistent, machine-readable storage media 1690-2 having stored therein software 1695 and/or instructions executable by processing circuitry 1660. Software 1695 may include any type of software including software for instantiating one or more virtualization layers 1650 (also referred to as hypervisors), software to execute virtual machines 1640 as well as software allowing it to execute functions, features and/or benefits described in relation with some embodiments described herein.

Virtual machines 1640, comprise virtual processing, virtual memory, virtual networking or interface and virtual storage, and may be run by a corresponding virtualization layer 1650 or hypervisor. Different embodiments of the instance of virtual appliance 1620 may be implemented on one or more of virtual machines 1640, and the implementations may be made in different ways.

During operation, processing circuitry 1660 executes software 1695 to instantiate the hypervisor or virtualization layer 1650, which may sometimes be referred to as a virtual machine monitor (VMM). Virtualization layer 1650 may present a virtual operating platform that appears like networking hardware to virtual machine 1640.

As shown in FIG. 16, hardware 1630 may be a standalone network node with generic or specific components. Hardware 1630 may comprise antenna 16225 and may implement some functions via virtualization. Alternatively, hardware 1630 may be part of a larger cluster of hardware (e.g. such as in a data center or customer premise equipment (CPE)) where many hardware nodes work together and are managed via management and orchestration (MANO) 16100, which, among others, oversees lifecycle management of applications 1620.

Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, virtual machine 1640 may be a software implementation of a physical machine that runs programs as if they were executing on a physical, non-virtualized machine. Each of virtual machines 1640, and that part of hardware 1630 that executes that virtual machine, be it hardware dedicated to that virtual machine and/or hardware shared by that virtual machine with others of the virtual machines 1640, forms a separate virtual network elements (VNE).

Still in the context of NFV, Virtual Network Function (VNF) is responsible for handling specific network functions that run in one or more virtual machines 1640 on top of hardware networking infrastructure 1630 and corresponds to application 1620 in FIG. 16.

In some embodiments, one or more radio units 16200 that each include one or more transmitters 16220 and one or more receivers 16210 may be coupled to one or more antennas 16225. Radio units 16200 may communicate directly with hardware nodes 1630 via one or more appropriate network interfaces and may be used in combination with the virtual components to provide a virtual node with radio capabilities, such as a radio access node or a base station.

In some embodiments, some signaling can be performed by control system 16230, which may alternatively be used for communication between the hardware nodes 1630 and radio units 16200.

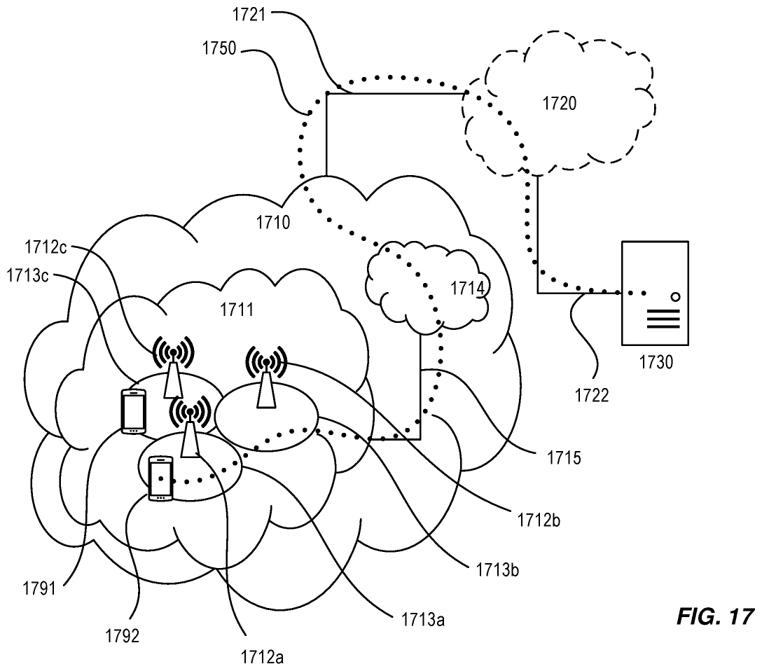

FIG. 17 illustrates a telecommunication network connected via an intermediate network to a host computer in accordance with some embodiments. With reference to FIG. 17, an embodiment of a communication system includes telecommunication network 1710, such as a 3GPP-type cellular network, which comprises access network 1711, such as a radio access network, and core network 1714. Access network 1711 comprises a plurality of base stations 1712a, 1712b, 1712c, such as NBs, eNBs, gNBs or other types of wireless access points, each defining a corresponding coverage area 1713a, 1713b, 1713c. Each base station 1712a, 1712b, 1712c is connectable to core network 1714 over a wired or wireless connection 1715. A first UE 1791 located in coverage area 1713c is configured to wirelessly connect to, or be paged by, the corresponding base station 1712c. A second UE 1792 in coverage area 1713a is wirelessly connectable to the corresponding base station 1712a. While a plurality of UEs 1791, 1792 are illustrated in this example, the disclosed embodiments are equally applicable to a situation where a sole UE is in the coverage area or where a sole UE is connecting to the corresponding base station 1712.

Telecommunication network 1710 is itself connected to host computer 1730, which may be embodied in the hardware and/or software of a standalone server, a cloud-implemented server, a distributed server or as processing resources in a server farm. Host computer 1730 may be under the ownership or control of a service provider, or may be operated by the service provider or on behalf of the service provider. Connections 1721 and 1722 between telecommunication network 1710 and host computer 1730 may extend directly from core network 1714 to host computer 1730 or may go via an optional intermediate network 1720. Intermediate network 1720 may be one of, or a combination of more than one of, a public, private or hosted network; intermediate network 1720, if any, may be a backbone network or the Internet; in particular, intermediate network 1720 may comprise two or more sub-networks (not shown).

The communication system of FIG. 17 as a whole enables connectivity between the connected UEs 1791, 1792 and host computer 1730. The connectivity may be described as an over-the-top (OTT) connection 1750. Host computer 1730 and the connected UEs 1791, 1792 are configured to communicate data and/or signaling via OTT connection 1750, using access network 1711, core network 1714, any intermediate network 1720 and possible further infrastructure (not shown) as intermediaries. OTT connection 1750 may be transparent in the sense that the participating communication devices through which OTT connection 1750 passes are unaware of routing of uplink and downlink communications. For example, base station 1712 may not or need not be informed about the past routing of an incoming downlink communication with data originating from host computer 1730 to be forwarded (e.g., handed over) to a connected UE 1791. Similarly, base station 1712 need not be aware of the future routing of an outgoing uplink communication originating from the UE 1791 towards the host computer 1730.

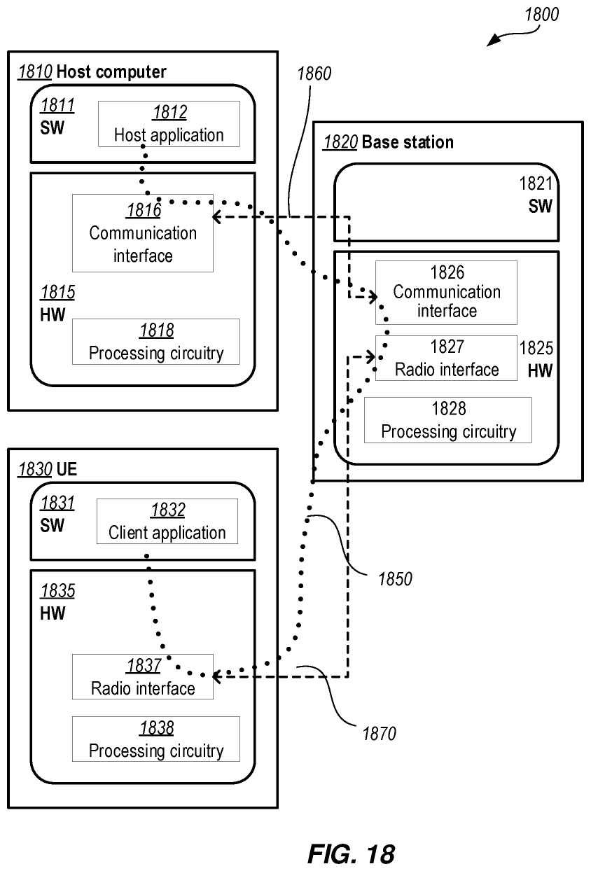

Example implementations, in accordance with an embodiment, of the UE, base station and host computer discussed in the preceding paragraphs will now be described with reference to FIG. 18. FIG. 18 illustrates host computer communicating via a base station with a user equipment over a partially wireless connection in accordance with some embodiments In communication system 1800, host computer 1810 comprises hardware 1815 including communication interface 1816 configured to set up and maintain a wired or wireless connection with an interface of a different communication device of communication system 1800. Host computer 1810 further comprises processing circuitry 1818, which may have storage and/or processing capabilities. In particular, processing circuitry 1818 may comprise one or more programmable processors, application-specific integrated circuits, field programmable gate arrays or combinations of these (not shown) adapted to execute instructions. Host computer 1810 further comprises software 1811, which is stored in or accessible by host computer 1810 and executable by processing circuitry 1818. Software 1811 includes host application 1812. Host application 1812 may be operable to provide a service to a remote user, such as UE 1830 connecting via OTT connection 1850 terminating at UE 1830 and host computer 1810. In providing the service to the remote user, host application 1812 may provide user data which is transmitted using OTT connection 1850.

Communication system 1800 further includes base station 1820 provided in a telecommunication system and comprising hardware 1825 enabling it to communicate with host computer 1810 and with UE 1830. Hardware 1825 may include communication interface 1826 for setting up and maintaining a wired or wireless connection with an interface of a different communication device of communication system 1800, as well as radio interface 1827 for setting up and maintaining at least wireless connection 1870 with UE 1830 located in a coverage area (not shown in FIG. 18) served by base station 1820. Communication interface 1826 may be configured to facilitate connection 1860 to host computer 1810. Connection 1860 may be direct, or it may pass through a core network (not shown in FIG. 18) of the telecommunication system and/or through one or more intermediate networks outside the telecommunication system. In the embodiment shown, hardware 1825 of base station 1820 further includes processing circuitry 1828, which may comprise one or more programmable processors, application-specific integrated circuits, field programmable gate arrays or combinations of these (not shown) adapted to execute instructions. Base station 1820 further has software 1821 stored internally or accessible via an external connection.

Communication system 1800 also includes UE 1830 (mentioned above), whose hardware 1835 may include radio interface 1837 configured to set up and maintain wireless connection 1870 with a base station serving a coverage area in which UE 1830 is currently located. Hardware 1835 of UE 1830 further includes processing circuitry 1838, which may comprise one or more programmable processors, application-specific integrated circuits, field programmable gate arrays or combinations of these (not shown) adapted to execute instructions. UE 1830 further comprises software 1831, which is stored in or accessible by UE 1830 and executable by processing circuitry 1838. Software 1831 includes client application 1832. Client application 1832 may be operable to provide a service to a human or non-human user via UE 1830, with the support of host computer 1810. In host computer 1810, an executing host application 1812 may communicate with the executing client application 1832 via OTT connection 1850 terminating at UE 1830 and host computer 1810. In providing the service to the user, client application 1832 may receive request data from host application 1812 and provide user data in response to the request data. OTT connection 1850 may transfer both the request data and the user data. Client application 1832 may interact with the user to generate the user data that it provides.

It is noted that host computer 1810, base station 1820 and UE 1830 illustrated in FIG. 18 may be similar or identical to host computer 1530, one of base stations 1512a, 1512b, 1512c and one of UEs 1591, 1592 of FIG. 15, respectively. This is to say, the inner workings of these entities may be as shown in FIG. 18 and independently, the surrounding network topology may be that of FIG. 15.

In FIG. 18, OTT connection 1850 has been drawn abstractly to illustrate the communication between host computer 1810 and UE 1830 via base station 1820, without explicit reference to any intermediary devices and the precise routing of messages via these devices. Network infrastructure may determine the routing, which it may be configured to hide from UE 1830 or from the service provider operating host computer 1810, or both. While OTT connection 1850 is active, the network infrastructure may further take decisions by which it dynamically changes the routing (e.g., on the basis of load balancing consideration or reconfiguration of the network).

Wireless connection 1870 between UE 1830 and base station 1820 is in accordance with the teachings of the embodiments described throughout this disclosure. One or more of the various embodiments improve the performance of OTT services provided to UE 1830 using OTT connection 1850, in which wireless connection 1870 forms the last segment. More precisely, the teachings of these embodiments may improve the system performance when control channel resources overlap. This may in turn reduce control signaling transmission attempts and/or increase control signaling throughput and thereby provide benefits such as reduced user waiting time, better responsiveness, and extended battery lifetime.

A measurement procedure may be provided for the purpose of monitoring data rate, latency and other factors on which the one or more embodiments improve. There may further be an optional network functionality for reconfiguring OTT connection 1850 between host computer 1810 and UE 1830, in response to variations in the measurement results. The measurement procedure and/or the network functionality for reconfiguring OTT connection 1850 may be implemented in software 1811 and hardware 1815 of host computer 1810 or in software 1831 and hardware 1835 of UE 1830, or both. In embodiments, sensors (not shown) may be deployed in or in association with communication devices through which OTT connection 1850 passes; the sensors may participate in the measurement procedure by supplying values of the monitored quantities exemplified above, or supplying values of other physical quantities from which software 1811, 1831 may compute or estimate the monitored quantities. The reconfiguring of OTT connection 1850 may include message format, retransmission settings, preferred routing etc.; the reconfiguring need not affect base station 1820, and it may be unknown or imperceptible to base station 1820. Such procedures and functionalities may be known and practiced in the art. In certain embodiments, measurements may involve proprietary UE signaling facilitating host computer 1810's measurements of throughput, propagation times, latency and the like. The measurements may be implemented in that software 1811 and 1831 causes messages to be transmitted, in particular empty or ‘dummy’ messages, using OTT connection 1850 while it monitors propagation times, errors etc.

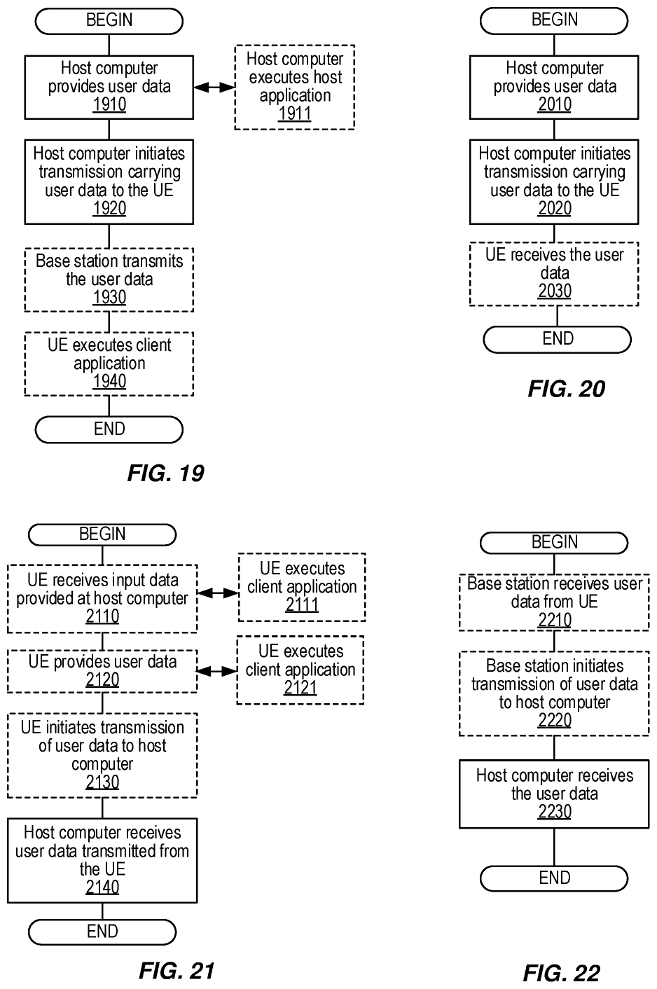

FIG. 19 is a flowchart illustrating a method implemented in a communication system, in accordance with one embodiment. The communication system includes a host computer, a base station and a UE which may be those described with reference to other figures. In operation 1910, the host computer provides user data. In sub-operation 1911 (which may be optional) of operation 1910, the host computer provides the user data by executing a host application. In operation 1920, the host computer initiates a transmission carrying the user data to the UE. In operation 1930 (which may be optional), the base station transmits to the UE the user data which was carried in the transmission that the host computer initiated, in accordance with the teachings of the embodiments described throughout this disclosure. In operation 1940 (which may also be optional), the UE executes a client application associated with the host application executed by the host computer.

FIG. 20 is a flowchart illustrating a method implemented in a communication system, in accordance with one embodiment. The communication system includes a host computer, a base station and a UE which may be those described with reference to other figures. In operation 2010, the host computer provides user data. In an optional sub-operation (not shown) the host computer provides the user data by executing a host application. In operation 2020, the host computer initiates a transmission carrying the user data to the UE. The transmission may pass via the base station, in accordance with the teachings of the embodiments described throughout this disclosure. In operation 2030 (which may be optional), the UE receives the user data carried in the transmission.

FIG. 21 is a flowchart illustrating a method implemented in a communication system, in accordance with one embodiment. The communication system includes a host computer, a base station and a UE which may be those described with reference to other figures. In operation 2110 (which may be optional), the UE receives input data provided by the host computer. Additionally or alternatively, in operation 2120, the UE provides user data. In sub-operation 2121 (which may be optional) of operation 2120, the UE provides the user data by executing a client application. In sub-operation 2111 (which may be optional) of operation 2110, the UE executes a client application which provides the user data in reaction to the received input data provided by the host computer. In providing the user data, the executed client application may further consider user input received from the user. Regardless of the specific manner in which the user data was provided, the UE initiates, in sub-operation 2130 (which may be optional), transmission of the user data to the host computer. In operation 2140 of the method, the host computer receives the user data transmitted from the UE, in accordance with the teachings of the embodiments described throughout this disclosure.

FIG. 22 is a flowchart illustrating a method implemented in a communication system, in accordance with one embodiment. The communication system includes a host computer, a base station and a UE which may be those described with reference to other figures. In operation 2210 (which may be optional), in accordance with the teachings of the embodiments described throughout this disclosure, the base station receives user data from the UE. In operation 2220 (which may be optional), the base station initiates transmission of the received user data to the host computer. In operation 2230 (which may be optional), the host computer receives the user data carried in the transmission initiated by the base station.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures that, although not explicitly shown or described herein, embody the principles of the disclosure and can be thus within the spirit and scope of the disclosure. Various exemplary embodiments can be used together with one another, as well as interchangeably therewith, as should be understood by those having ordinary skill in the art.

The term unit, as used herein, can have conventional meaning in the field of electronics, electrical devices and/or electronic devices and can include, for example, electrical and/or to electronic circuitry, devices, modules, processors, memories, logic solid state and/or discrete devices, computer programs or instructions for carrying out respective tasks, procedures, computations, outputs, and/or displaying functions, and so on, as such as those that are described herein.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

As described herein, device and/or apparatus can be represented by a semiconductor chip, a chipset, or a (hardware) module comprising such chip or chipset; this, however, does not exclude the possibility that a functionality of a device or apparatus, instead of being hardware implemented, be implemented as a software module such as a computer program or a computer program product comprising executable software code portions for execution or being run on a processor. Furthermore, functionality of a device or apparatus can be implemented by any combination of hardware and software. A device or apparatus can also be regarded as an assembly of multiple devices and/or apparatuses, whether functionally in cooperation with or independently of each other. Moreover, devices and apparatuses can be implemented in a distributed fashion throughout a system, so long as the functionality of the device or apparatus is preserved. Such and similar principles are considered as known to a skilled person.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

In addition, certain terms used in the present disclosure, including the specification, drawings and exemplary embodiments thereof, can be used synonymously in certain instances, including, but not limited to, e.g., data and information. It should be understood that, while these words and/or other words that can be synonymous to one another, can be used synonymously herein, that there can be instances when such words can be intended to not be used synonymously. Further, to the extent that the prior art knowledge has not been explicitly incorporated by reference herein above, it is explicitly incorporated herein in its entirety. All publications referenced are incorporated herein by reference in their entireties.

Embodiments of the techniques and apparatus described herein include, but are not limited to, the following enumerated examples:

E1. A method, performed by a network node in a wireless network, of managing network resources based on one or more application-level performance requirements associated with an application hosted by one or more UEs served by the wireless network, the method comprising:
receiving the application-level performance requirements from an application server;
mapping the application-level performance requirements to one or more network performance requirements, wherein the mapping is based on a Markov chain model; and
based on the network performance requirements, configuring at least one of the following for data transmission and/or reception associated with the application: the one or more UEs, and respective serving cells for the one or more UEs.
   E2. The method of embodiment E1, wherein the application-level performance requirements include any of the following:
availability according to a predetermined quality of service (QoS);
reliability, relating to a duration between application outages; and
survival time, relating to the maximum number of consecutive lost packets that will not cause an application outage.
   E3. The method of any of embodiments E1-E2, wherein the network performance requirements include at least two of the following:
a mean time to repair (MTTR), relating to an average number of consecutive packet losses;
a mean time between failure (MTBF), relating to an average number of consecutive successful packets; and
a packet error rate.
   E4. The method of any of embodiments E1-E3, wherein configuring for data transmission and/or reception based on the network performance requirements comprises:
selecting one or more first techniques for reliability enhancement (TREs) needed to meet the network performance requirements; and
configuring at least one of the following to use the first TREs when transmitting and/or receiving data associated with the application: the one or more UEs, and respective serving cells for the one or more UEs.
   E5. The method of embodiment E4, wherein the one or more first TREs include any of the following:
carrier aggregation and/or dual connectivity;
data message repetition;
link adaptation based on modulation and coding scheme (MCS);
multi-antenna transmission and/or reception;
MAC-layer multiplexing and/or retransmission;
RLC-layer retransmission; and
PDCP-layer duplication.
   E6. The method of any of embodiments E1-E5, further comprising,
during the transmission and/or reception of the data associated with the application, determining one or more network performance parameters;
mapping the determined network performance parameters to application-level performance parameters based on the Markov chain model;
determining whether the application-level performance parameters fulfill the application-level performance requirements; and
based on determining that the application-level performance parameters do not fulfill the application-level performance requirements:
   selecting one or more second techniques for reliability enhancement (TREs) needed to meet the network performance requirements associated with the application-level performance requirements; and
   configuring at least one of the following to use the second TREs when transmitting and/or receiving subsequent data associated with the application: the one or more UEs, and respective serving cells for the one or more UEs.
      E7. The method of any of embodiments E1-E6, wherein:
the Markov chain model comprises a state space partitioned into Nₛᵥ+2 states, [symbol] ={ [symbol] _{N}, 1, 2, . . . , [symbol] ₛᵥ, [symbol] };
Nₛᵥ is a survival time of the application;
state [symbol] _{N} represents a time that the wireless network is available; and
state [symbol] represents a time that application becomes unavailable after Nₛᵥ consecutive packet failure events.
   E8. The method of any of embodiments E1-E7, wherein the wireless network is a 5G network, and wherein the network node is one of the following:
a gNB or component thereof;
an access and mobility management function (AMF); and
a user plane function (UPF).
   E9. The method of any of embodiments E1-E8, wherein the application is a cyber-physical control application.
   E10. A network node, of a wireless network, configured to manage network resources based on one or more application-level performance requirements associated with an application hosted by one or more UEs served by the wireless network, the network node comprising:
interface circuitry configured to communicate with an application server, one or more further network nodes, and one or more UEs; and
processing circuitry operatively coupled to the interface circuitry, whereby the processing circuitry and the interface circuitry are configured to perform operations corresponding to any of the methods of embodiments E1-E9.
   E11. A network node, of a wireless network, configured to manage network resources based on one or more application-level performance requirements associated with an application hosted by one or more UEs served by the wireless network, the network node being further arranged to perform operations corresponding to any of the methods of embodiments E1-E9.
   E12. A non-transitory, computer-readable medium storing computer-executable instructions that, when executed by processing circuitry of a network node, configure the network node to perform operations corresponding to any of the methods of embodiments E1-E9.
   E13. A computer-program product comprising computer-executable instructions that, when executed by processing circuitry of a network node, configure the network node to perform operations corresponding to any of the methods of embodiments E1-E9.

1.-32. (canceled)

33. A method for a network node of a wireless network to manage network resources, the method comprising:
mapping one or more application-level performance requirements to one or more network performance requirements, wherein:
the mapping is based on a Markov chain model, and
the application-level performance requirements are associated with an application hosted by one or more user equipment (UEs) served by the wireless network; and
based on the network performance requirements, configuring at least one of the following for data transmission and/or reception associated with the application: the one or more UEs, and respective serving cells for the one or more UEs.

34. The method of claim 33, wherein the application-level performance requirements include any of the following:
availability, A, of the application according to a predetermined quality of service;
reliability, R, relating to a mean time between application outages; and
survival time, N_sv, relating to a maximum number of consecutive lost packets that will not cause an application outage.

35. The method of claim 33, wherein the mapping is based on three parameters associated with the application-level performance requirements.

36. The method of claim 33, wherein the network performance requirements include any of the following:
mean time to repair, τ̅_{TR}, relating to an average number of consecutive packet losses;
mean time between failure, τ̅_{BF}, relating to an average number of consecutive successfully-received packets; and
packet error rate (PER).

37. The method of claim 33, wherein:
the Markov chain model comprises a state space partitioned into Nₛᵥ+2 states, [symbol] ={ [symbol] _{N}, 1, 2, . . . , [symbol] ₛᵥ, [symbol] };
Nₛᵥ is a survival time of the application;
state [symbol] _{N} represents a time that the wireless network is available; and
state [symbol] represents a time that application becomes unavailable after Nₛᵥ consecutive packet losses.

38. The method of claim 37, wherein the Markov chain model further comprises a state transition matrix (M) having entries that are based on the following network performance requirements:
mean time to repair, τ̅_{TR}, relating to an average number of consecutive packet losses; and
mean time between failure, τ̅_{BF}, relating to an average number of consecutive successfully transmitted packets.

39. The method of claim 33, further comprising receiving the application-level performance requirements from an application server associated with the application.

40. The method of claim 33, wherein configuring for data transmission and/or reception based on the network performance requirements comprises:
selecting one or more techniques for reliability enhancement (TREs) needed to meet the network performance requirements; and
configuring at least one of the following to use the selected TREs when transmitting and/or receiving data associated with the application: the one or more UEs, and respective serving cells for the one or more UEs.

41. A method for a network node of a wireless network to manage network resources, the method comprising:
mapping one or more network performance parameters to one or more application-level performance metrics, wherein:
the mapping is based on a Markov chain model,
the application-level performance metrics are associated with an application hosted by one or more user equipment (UEs) served by the wireless network, and
the network performance parameters represent performance of the wireless network during transmission and/or reception of data associated with the application; and
monitoring whether the one or more application-level performance metrics fulfill corresponding one or more application-level performance requirements associated with the application.

42. The method of claim 41, wherein the application-level performance metrics include any of the following:
availability, A, of the application according to a predetermined quality of service;
reliability, R, relating to a mean time between application outages; and
survival time, N_sv, relating to a maximum number of consecutive lost packets.

43. The method of claim 41, wherein the network performance parameters include any of the following:
mean time to repair, τ̅_{TR}, relating to an average number of consecutive packet losses;
mean time between failure, τ̅_{BF}, relating to an average number of consecutive successfully-received packets; and
packet error rate (PER).

44. The method of claim 41, wherein the mapping is based on two network performance parameters.

45. The method of claim 41, wherein:
the Markov chain model comprises a state space partitioned into Nₛᵥ+2 states, [symbol] ={ [symbol] _{N}, 1, 2, . . . , [symbol] ₛᵥ, [symbol] };
Nₛᵥ is a survival time of the application;
state [symbol] _{N} represents a time that the wireless network is available; and
state [symbol] represents a time that application becomes unavailable after Nₛᵥ consecutive packet losses.

46. The method of claim 45, wherein the Markov chain model further comprises a state transition matrix (M) having entries that are based on the following network performance parameters:
mean time to repair, τ̅_{TR}, relating to an average number of consecutive packet losses; and
mean time between failure, τ̅_{BF}, relating to an average number of consecutive successfully transmitted packets.

47. The method of claim 41, further comprising receiving the application-level performance requirements from an application server associated with the application.

48. A network node of a wireless network, the network node being configured to manage network resources and comprising:
communication interface circuitry configured to communicate with an application server, with one or more further network nodes, and with one or more user equipment (UEs); and
processing circuitry operatively coupled to the communication interface circuitry, whereby the processing circuitry and the communication interface circuitry are configured to:
map one or more application-level performance requirements to one or more network performance requirements, wherein:
the mapping is based on a Markov chain model,
the application-level performance requirements are associated with an application hosted by the one or more UEs; and
based on the network performance requirements, configure at least one of the following for data transmission and/or reception associated with the application: the one or more UEs, and respective serving cells for the one or more UEs.

49. The network node of claim 48, wherein the application-level performance requirements include any of the following:
availability, A, of the application according to a predetermined quality of service;
reliability, R, relating to a mean time between application outages; and
survival time, N_sv, relating to a maximum number of consecutive lost packets that will not cause an application outage.

50. The network node of claim 48, wherein the network performance requirements include any of the following:
mean time to repair, τ̅_{TR}, relating to an average number of consecutive packet losses;
mean time between failure, τ̅_{BF}, relating to an average number of consecutive successfully-received packets; and
packet error rate (PER).

51. A network node of a wireless network, the network node being configured to manage network resources and comprising:
communication interface circuitry configured to communicate with an application server, with one or more further network nodes, and with one or more user equipment (UEs); and
processing circuitry operatively coupled to the communication interface circuitry, whereby the processing circuitry and the communication interface circuitry are configured to perform operations corresponding to the method of claim 41.

52. The network node of claim 51, wherein the application-level performance metrics include any of the following:
availability, A, of the application according to a predetermined quality of service;
reliability, R, relating to a mean time between application outages; and
survival time, N_sv, relating to a maximum number of consecutive lost packets.
